(19) United States
(12) Patent Application Publication
(10) Pub. No.: US 2024/0386403 A1
(43) Pub. Date: Nov. 21, 2024

(54) APPARATUS FOR TRANSMITTING A REQUEST

(71) Applicant: David FORTISCUE, Congleton (GB)

(72) Inventor: David FORTISCUE, Congleton (GB)

(21) Appl. No.: 18/287,493

(22) PCT Filed: Apr. 19, 2022
(86) PCT No.: PCT/GB2022/050986

§ 371 Date: Oct. 19, 2023

(30) Foreign Application Priority Data
Apr. 19, 2021 (GB) 2105588.4

(51) Int. Cl. G06Q 20/08; G06Q 20/38

(52) U.S. Cl. CPC G06Q 20/0855; G06Q 20/387

(57) ABSTRACT

There is described an apparatus for transmitting a request, the apparatus comprising: a processor arranged to: determine a score for a user in dependence on the behaviour of the user; identify a request from the user, and determine a modifier associated with the request in dependence on one or more of: a feature of the request; and a party (e.g. a merchant) associated with the request; and a communication interface arranged to transmit a transaction to a separate apparatus in dependence on the request, the score, and the modifier.

### FIELD OF THE INVENTION

The present disclosure relates to an apparatus for transmitting a request as well as a system for, and method of, outputting a request and an apparatus for, system for, and method of, outputting a modifier.

### BACKGROUND

Consumers shopping either on-line or in merchants' physical stores often search for the best prices for the products they want and check to see if there are any discounts available on the products they want from a particular brand or merchant. Discounts can be offered in a number of ways, of which the primary ones are discount codes and vouchers. The discount codes and vouchers can be issued digitally or by paper.

Discount codes can also be referred to as a promo codes, discount codes, or voucher codes. Moreover, discount codes can be for a specific product, a basket of products or a specific brand. If the discount is for on-line only, the consumer obtains a discount code which can be entered into a merchants' online checkout or shopping cart and the price of the product(s) is reduced according to the level of discount that a specific discount code provides. Once the discount code has been entered and the price reduced, the consumer then proceeds to make a payment and “checks out” completing their on-line purchase. There are up to six stages for a consumer to checkout with the current traditional on-line checkout which includes: “select product; choose size/colour preferences; add to basket; review basket; insert promotional/discount code, checkout and choose payment method”, and each stage can reduce customer conversion and cause inconvenience to the consumer.

If the discount is for in-store only, the consumer generally receives a either a paper or digital voucher from a merchant or brand, which contains a barcode; this barcode is scanned at the merchants' point of sale and the price of the consumers' product(s) is reduced according to the level of discount set by the merchant or brand.

In order for the consumer to find out if there is a discount available for the product or brand they want to purchase, the consumer has a number of options: (1) look for a voucher sent to them from a merchant that they shop at and that can be redeemed at that specific merchant either on-line or in store depending on the type of voucher issued; (2) search for discount codes from discount code aggregators; (3) use a discount code provider that provides a browser extension that interfaces with a merchants' website and searches for available discount codes and then tests each one by applying the discount code into the discount code or promo field to see if it works.

Each of the three options described for the consumer to find, obtain and apply the discount can result in the consumer feeling frustrated with the experience.

### SUMMARY OF THE DISCLOSURE

According to an aspect of the present disclosure, there is described an apparatus for transmitting a request, the apparatus comprising: a processor arranged to: determine a score for a user in dependence on the behaviour of the user; identify a request from the user; and determine a modifier associated with the request in dependence on one or more of: a feature of the request; and a party (e.g. a merchant) associated with the request; and a communication interface arranged to transmit a transaction to a separate apparatus in dependence on the request, the score, and the modifier.

Preferably, the communication interface is arranged to transmit an offer transaction to one or more third party devices, wherein the offer transaction is dependent on the request, the score, the modifier, and, optionally, an input of the user.

Preferably, the communication interface is arranged to receive one or more bid transactions from the third party devices, wherein the transaction depends on the bid transactions, preferably wherein each bid transaction is associated with a payment means, and wherein the transaction is dependent on the payment means associated with a winning bid transaction.

Preferably, the apparatus is arranged to determine a winning bid based on payment means and/or payment terms associated with each bid.

Preferably, the request relates to one or more of: a purchase, an exchange; a good; and a service.

Preferably, the party associated with the request comprises a merchant.

Preferably, the apparatus is arranged to receive a merchant value associated with the party from a system server and to determine the modifier based on the merchant value. Preferably, the apparatus is arranged to receive the modifier from a system server.

Preferably, the apparatus is arranged to receive user information indicating the behaviour of the user from a client device. Preferably, the user information comprises user characteristics and/or user banking data. Preferably, the apparatus is arranged to receive the score from a client device.

Preferably, the separate apparatus comprises a merchant server.

Preferably, the communication interface is arranged to receive a notification from the separate apparatus indicating a success of the request.

Preferably, the apparatus comprises a user interface and/or a communication interface for receiving an input of the user, wherein the transaction is dependent on the input of the user.

Preferably, the apparatus is arranged to receive the user input and then to determine the score, the modifier, and the transaction in a single action and/or based on a single user input.

Preferably, determining the score comprises identifying a client identifier associated with the user and identifying a score associated with the client identifier.

Preferably, the transaction is dependent on a server associated with the party and/or wherein the apparatus is arranged to interact with a website of the party.

Preferably, the processor is arranged to determine a preference of the user, wherein the transaction is dependent on the preference. Preferably, the preference relates to one or more of: a user's size; a user's age; and a user's shopping history.

Preferably, the transaction comprises a payment transaction.

Preferably, the processor is arranged to determine, in dependence on the score and/or the modifier, one or more of: a discount; a change in ownership; and a reward for the user.

Preferably, the request relates to a non-fungible token and/or preferably wherein the transaction relates to a request to record a transaction on a blockchain.

Preferably, the processor is arranged to determine a time associated with the purchase of a similar good by at least one other user, and wherein the communication interface is arranged to transmit the request in dependence on the determined time.

Preferably, the modifier is determined in dependence on one or more of: a previous purchase of the user; a similar good that the user has purchased previously, preferably a quantity and/or quality associated with the similar good; a merchant and/or brand associated with a previous purchase of the user; and an amount previously spent by the user on the good and/or on similar goods.

Preferably, the apparatus is associated with a first party and/or brand and the modifier is dependent on the behaviour of the user in relation to a second party and/or brand.

Preferably, the score is determined in dependence on: the purchasing and/or financial behaviour and capacity of the user; and/or a promotion of the good by the user.

Preferably, the processor and/or the communication interface is arranged to query a database, preferably a remote database, so as to determine the modifier.

Preferably, the database defines an association between the score of the user and one or more of: a group of goods; a good; a user's previous behaviour; a user's previous purchases; and a spend associated with a user and a party and/or brand.

Preferably, the database queried by the processor and/or the communication interface is dependent on the request and/or a party associated with the request.

Preferably, the processor is arranged to determine a database to query.

Preferably, the transaction is dependent on one or more of: a request to purchase a good; payment information relating to the user; and the modifier; and/or wherein the request comprises personalisation information relating to a preference of the user.

Preferably, the processor is arranged to determine whether the user can afford a good and/or service associated with the request.

Preferably, the processor is arranged to determine a price associated with the request, preferably wherein the price is dependent on the modifier.

Preferably, the processor is arranged to determine a number of points held by the user, preferably wherein the transaction is dependent on the number of points.

Preferably, the processor is arranged to determine a plurality of modifiers, preferably wherein each modifier relates to one or more of: a different party; a different brand; and a similar request.

Preferably, the processor is arranged to: determine one or more further users considering making similar requests and/or purchasing similar good, preferably wherein the modifier is determined in dependence on the further users; and/or determine and/or output an environmental impact of the request; and/or determine a plurality of modifiers for a plurality of requests, and output each of the plurality of modifiers.

Preferably, the apparatus comprises one or more of: a user interface arranged to output the modifier to the user; a communication interface arranged to transmit the modifier to a separate device; a communication interface arranged to output and/or transmit the modifier to a separate device and/or user, preferably a separate device and/or user is selected by the user and a communication interface arranged to transmit a transaction relating to the request.

Preferably, the apparatus comprises a processor arranged to determine a lending rate for the user in dependence on the behaviour of the user.

Preferably, the discount is determined in dependence on one or more of: Open Banking, Credit Bureau, receipts/invoices, and order confirmations.

Preferably, the apparatus comprises a processor arranged to: determine an original price of a good, apply the modifier to the original price so as to determine a discounted price, and optionally, output the discounted price.

Preferably, the apparatus comprises a processor arranged to determine a value of the user based on the behaviour of the user.

Preferably, the apparatus comprises a processor arranged to determine the modifier based on a permission granted by the user, preferably wherein the processor is arranged to determine a user input specifying types of user information that are useable to determine the modifier.

According to another aspect of the present disclosure, there is described an apparatus for transmitting a request, the apparatus comprising: a processor arranged to: determine a score for a user in dependence on the behaviour of the user; and identify a request from the user; determine a modifier associated with the request in dependence on one or more of: the request; and a party associated with the request; and a communication interface arranged to transmit an offer transaction to one or more third party devices, wherein the offer transaction is dependent on the request, the score, and the modifier, and wherein the communication interface is arranged to receive one or more bid transactions from the third party devices and to form a transaction in dependence on the bid transactions.

According to another aspect of the present disclosure, there is described a system comprising the apparatus of any preceding claim, preferably comprising one or more of: a client device, a system server, and the merchant device.

According to another aspect of the present disclosure, there is described a system comprising: a client device comprising: a processor for determining user information relating to the behaviour of a user; and a communication interface for transmitting the user information to a system server; the system server comprising: a processor for: determining a score for the user in dependence on the behaviour of the user; and determining a modifier associated with a good in dependence on one or more of: the good; and a merchant associated with the good; and a communication interface for receiving the user information from the client device and transmitting a request to a merchant server, wherein the request is dependent on the good, the score, the modifier, and the input of the user.

According to another aspect of the present disclosure, there is described an apparatus for outputting a modifier, the apparatus comprising: a processor arranged to: determine a score for a user in dependence on the purchasing and financial behaviour and capacity of the user; and determine a modifier for the user for a good in dependence on the score; and a user interface for and/or a communication interface arranged to output the modifier.

According to another aspect of the present disclosure, there is described a system for outputting a modifier, the system comprising: a score-determining apparatus for determining a score for a user in dependence on the purchasing and financial behaviour and capacity of the user; a modifier-determining apparatus for determining a modifier for the user for a good in dependence on the score; and an output-apparatus for outputting the modifier.

According to another aspect of the present disclosure, there is described a method of outputting a modifier, the method comprising: determining a score for a user in dependence on the purchasing and financial behaviour and capacity of the user; determining a modifier for the user for a good in dependence on the score; and outputting the modifier.

According to another aspect of the present disclosure, there is described a method of for transmitting a request, the method comprising: determining a score for a user in dependence on the behaviour of the user; and identifying a good; determining a modifier associated with the good in dependence on one or more of: the good; and a merchant associated with the good; and transmitting a request in dependence on the good, the score, and the modifier.

According to at least one aspect of the present disclosure, there is described: a method of outputting a modifier, the method comprising: determining a score for a user in dependence on the purchasing and financial behaviour and capacity of the user; determining a modifier for the user for a good in dependence on the score; and outputting the modifier.

Preferably, the modifier comprises one or more of: a discount on the good, points for purchasing the good, and an offer for the good.

Preferably, outputting the modifier comprises transmitting a payment request.

Preferably, the payment request is dependent on one or more of: a request to purchase the good; payment information relating to the user; and the modifier.

Preferably, the payment request comprises personalisation information relating to a preference of the user.

Preferably, the score is determined in dependence on a promotion of the good by the user.

Preferably, the method comprises determining that the user can afford the good.

Preferably, the method comprises determining a time associated with the purchase of a similar good by at least one other user. Preferably, outputting the modifier comprises outputting the modifier in dependence on the determined time.

Preferably, the method comprises determining a price for the good. Preferably, the price is dependent on the modifier.

Preferably, the method comprises determining a number of points held by the user. Preferably, the price depends on the number of points.

Preferably, the method comprises determining an amount of cashback for the user. Preferably, the cashback is dependent on the modifier.

Preferably, the method comprises determining a plurality of modifiers. Preferably, each modifier relates to one or more of: a different merchant; a different brand; and a similar good.

Preferably, the method comprises determining one or more further users considering purchasing the same good. Preferably, the modifier is determined in dependence on the further users.

Preferably, the method comprises determining and/or outputting an environmental impact of the good.

Preferably, the method comprises determining a plurality of modifiers for a plurality of goods, and outputting each of the plurality of modifiers.

Preferably, outputting the modifier comprises one or more of: outputting the modifier to the user; transmitting the modifier to a separate device; outputting and/or transmitting the modifier to a separate device and/or user, preferably a separate device and/or user is selected by the user and transmitting a payment request relating to the good.

Preferably, the method comprises determining a lending rate for the user in dependence on the score.

Preferably, the score is determined in dependence on one or more of: Open Banking, Credit Bureau, receipts/invoices, and order confirmations.

Preferably, the method comprises: determining an original price of the good, applying the modifier to the original price so as to determine a discounted price, and optionally, outputting the discounted price.

Preferably, the method comprises determining a value of the user based on the score.

Preferably, the method comprises determining the modifier based on a permission granted by the user. Preferably, the method comprises determining a user input specifying accessible types of user information that are useable to determine the modifier.

Preferably, determining the modifier comprises querying a database, preferably a remote database.

Preferably, the database defines an association between the score of the user and one or more of: a group of goods; a good; a user's previous behaviour; a user's previous purchases; and a spend associated with a user and a merchant and/or brand.

Preferably, the database is dependent on the good and/or a merchant associated with the good, preferably wherein the method comprises determining a database to query.

Preferably, determining the score comprises determining a category for the user.

Preferably, the score is determined in dependence on one or more of: a previous purchase of the user; a similar good that the user has purchased previously, preferably a quantity and/or quality associated with the similar good; a merchant and/or brand associated with a previous purchase of the user; and an amount previously spent by the user on the good and/or on similar goods.

According to another aspect of the present invention, there is described an apparatus for outputting a modifier, the apparatus comprising: means for (e.g. a processor arranged to) determining a score for a user in dependence on the purchasing and financial behaviour and capacity of the user; means for (e.g. a processor arranged to) determining a modifier for the user for a good in dependence on the score; and means for (e.g. a user interface for and/or a communication interface arranged to) outputting the modifier.

Preferably, the apparatus is associated with a first merchant and/or brand and the score is dependent on the behaviour of the user in relation to a second merchant and/or brand.

According to another aspect of the present disclosure, there is described a system for outputting a modifier, the system comprising: a score-determining apparatus for determining a score for a user in dependence on the purchasing and financial behaviour and capacity of the user; a modifier-determining apparatus for determining a modifier for the user for a good in dependence on the score; and an output-apparatus for outputting the modifier.

According to another aspect of the present disclosure, there is described a system for outputting a modifier, the system comprising: a score-determining apparatus comprising means for (e.g. a processor arranged to) determining a score for a user in dependence on the purchasing and financial behaviour and capacity of the user; a modifier-determining apparatus comprising means for (e.g. a processor arranged to) determining a modifier for the user for a good in dependence on the score; and an output-apparatus comprising means for (e.g. a user interface and/or a communication interface arranged to) outputting the modifier.

Preferably, one of the apparatuses comprises means for (e.g. a processor arranged to) determining whether the user can afford the good.

Preferably, one of the apparatuses comprises means for (e.g. a processor arranged to) determining a time associated with the purchase of a similar good by at least one other user, and wherein the output-apparatus is arranged to output the modifier in dependence on the determined time.

Preferably, one of the apparatuses comprises means for (e.g. a processor arranged to) determining a price for the good, preferably wherein the price is dependent on the modifier.

Preferably, one of the apparatuses comprises means for (e.g. a processor arranged to) determining a number of points held by the user, preferably wherein the price depends on the number of points.

Preferably, one of the apparatuses comprises means for (e.g. a processor arranged to) determining an amount of cashback for the user, preferably wherein the cashback is dependent on the modifier.

Preferably, one of the apparatuses comprises means for (e.g. a processor arranged to): determining one or more further users considering purchasing the same good, preferably wherein the modifier is determined in dependence on the further users; and/or determining and/or outputting an environmental impact of the good; and/or determining a plurality of modifiers for a plurality of goods, and outputting each of the plurality of modifiers.

Preferably, one of the apparatuses comprises means for (e.g. a processor arranged to) determining a lending rate for the user in dependence on the score.

Preferably, one of the apparatuses comprises means for (e.g. a processor arranged to): determining an original price of the good, applying the modifier to the original price so as to determine a discounted price, and optionally, outputting the discounted price.

Preferably, one of the apparatuses comprises means for (e.g. a processor arranged to) determining a value of the user based on the score.

Preferably, the score-determining apparatus and the modifier-determining apparatus are the same apparatus.

Preferably, the score-determining apparatus and the modifier-determining apparatus are different apparatuses. Preferably, the modifier-determining apparatus and the output-apparatus are the same apparatus.

Preferably, the modifier-determining apparatus comprises a processor for accessing a database, wherein the database relates scores and modifiers.

According to another aspect of the present disclosure, there is described an apparatus for outputting a modifier, the apparatus comprising: a processor arranged to: identify a good; and determine a discount for a user in dependence on the behaviour of the user and the good; a user interface arranged to: present the discount to the user; and receive an input of the user; and a communication interface arranged to transmit a payment request to a separate apparatus in dependence on the good, the discount, and the input of the user.

The present disclosure seeks to address the background and challenges presented. There are three primary aspects to the present disclosure. Firstly, the present disclosure enables consumers to understand their individual purchasing power with a transparent, globally standardised metric that they can use to help inform them of their own individual value, what that value represents to merchants and the discounts/pricing they should expect from merchants and brands.

Secondly, discount codes/personalised pricing is dynamically generated in real time that react to a consumers' spending capacity and intended purchases and applied using a novel applicator for the specific products consumers want at a discount level that represents the value a consumer can bring to a retailer or other provider without the consumer viewing or entering any discount codes.

Thirdly, the present disclosure enables consumers to make the optimum payment choice for every single purchase they make by using affordability assessments for each and every purchase a consumer makes, whereby an indicator displaying “Yes” or “No” is presented to the consumer, and this is combined with an intelligent payment assistant that enables real time bank/lender bidding on individual purchases. The payment is applied simultaneously with the discount using a one click or voice command single action discount and pay.

The present disclosure comprises three aspects therefore that result in the best shopping experience: (1) a consumer purchasing power score; (2) a discount code/personalised price; (3) a payment. All three elements are amalgamated into one single dynamic discount code/personalised price and payment generator and applicator called the Dynamic Discount Code & Payment Manager (DDCPM). The DDCPM is a reactor to consumers' financial and purchasing behaviour, in that it injects personalised preferences such as sizes, colours, materials etc, generates discount codes/personalised pricing, injects those discount codes into merchants' checkouts or sends a pricing instruction to the merchants' server, performs an affordability assessment on single or multiple products, decides on the best payment method and injects the payment data into merchants' checkouts. The system can be deployed for both on-line purchases and in physical store purchases.

The system can be configured to either inject personalised preferences, discount codes and tokenised payment data into a merchant shopping cart or it can send a message to the server with the relevant data. That is to say, a client device can send a message to the server containing all the required data that the merchant needs to fulfil a product order. Given that the required fields already exist within a shopping cart system, it may be preferable that the system simply injects the relevant data into the cart system.

Thus, the three central elements to the present disclosure are: (1) Consumer Purchasing Power Score (the qualifier, which qualifies the consumer for the relevant discount/personalised price); (2) Dynamic Discount Code & Payment Manager (the generator and applicator of discount codes and/or prices with simultaneous payment application); and single action Discount & Pay (the requestor, such as a button, that the consumer selects/touches to order their products). The three work together to enable consumers to obtain discounts/personalised pricing based on their purchasing and financial behaviours and the best payment method for their financial situation with one single action click or voice command, touch screen, keyboard stroke, biometrics etc.

Firstly, the consumer installs the Discount Code & Payment Manager (DDCPM). Secondly, the consumer obtains their Consumer Purchasing Power Score (CPPS) by sharing their Open Banking and receipt data with the DDCPM, which may then qualify them for specific discounts from brands and retailers/merchants. Thirdly, the consumer views a product or products they want on merchants' apps or websites and the discount and/or price is displayed once the server receives an instruction from the DDCPM. Finally, the consumer can select to purchase online or in physical stores, their chosen products using a one click touch or voice command single action Discount and Pay, which simultaneously applies their discount and makes payment without the consumer having to view any discount codes or decide on or enter any payment information. The result is the consumer obtains a personalised discount/price in the form of a code that they do not have to view or enter, and can pay and checkout either on-line or in store with the best available discount, using the optimum payment.

The Consumer Purchasing Power Score enables consumers to understand their own purchasing power and allows merchants to view and recognise individual consumer value on a much deeper level than before. Thus, if merchants can understand and identify value specific to an individual consumer across multiple merchant categories, merchants can provide personalised pricing or discounts to acquire and retain the most valuable consumers. Therefore, this means there will be a material increase in personalised pricing or discount codes, which in turn, requires a system that provides rapid and effective discount code/personalised pricing generation and application combined with payment application with one simple click, such as a touch screen, mouse button, voice command, keyboard stoke, or by biometrics etc.

In summary, the present disclosure enables consumers to: (1) understand their individual purchasing power with a Consumer Purchasing Power Score; (2) gain discounts/personalised pricing on products based on their Consumer Purchasing Power Score either via a single search on the system's platform to obtain a volume discount or within a merchant environment that offers a discount/personalised price based on the value a consumer may offer a particular merchant; (3) apply those discounts/personalised pricing, make payment and checkout with one applicator and single action Discount and Pay ordering functions. The single action one click functions can reside in a shopping cart and checkout system or as separate functions.

An embodiment of the present disclosure provides a method and system for: (1) enabling consumers to easily understand their own individual purchasing power that they could provide to different merchants and therefore what discounts they might reasonably expect when shopping; (2) obtaining a unique discount and discount code for on-line purchases without having to find or enter discount codes into a merchants' website or app and (3) enabling single action discount code generation, application and payment, which means the consumer simply has to click one button, single touch of a screen or voice command to find and apply a discount code and make payment simultaneously for instant discount/personalised price, payment and checkout.

The system enables the consumer to “checkout” from a merchants' website and/or app with one click ordering, discount and payment, which means the consumer does not have to enter a discount code or payment information, thereby enabling the merchant to remove discount code and payment fields where their customers select single action “One Click Discount & Pay” to purchase a product. This ensures the consumer has the best discount and uses the optimum payment method with one click.

In order to obtain a discount and make a payment with one click, the consumer shares their data including Open Banking data from client device to server. Server stores payment data. Server calculates the Consumers' Purchasing Power Score (CPPS). One embodiment means the consumer can share the data with merchants' server and the merchants' server would create a dynamic discount code.

An alternative embodiment would be for the system's server to hold a Merchant Value Scorecard which would contain the levels of discount a merchant was prepared to offer to consumers with particular Consumer Purchasing Power Scores. The system's server would then create a dynamic discount code that the merchant has agreed to and the server pushes dynamic discount codes to the client system, which are then stored in the Dynamic Discount Code & Payment Manager (DDCPM).

The discount codes can be applied to specific products or basket of products. Dynamic discount codes can also be generated by product views, products added to basket but not checked out in addition to using the CPPS. The DDCPM can also be configured to dynamically generate and inject discount codes based on activity on the client device rather than using the server to generate discount codes and then communicate to the DDCPM on client device.

Currently, all discounts are merchant or brand driven rather than consumer driven. That is to say that it is the brand or merchant that decides what product(s) and/or brands will be offered for discount and what level of discount will be offered. The consequence of this brand/merchant driven approach is that consumers can't find the discounts for the products they want or at a discount level they believe is meaningful to them.

The reason discounts often do not work, or more often, simply not available for the products or brands the consumer wants, is because the merchant or brand does not have visibility or any understanding of the total potential value an individual consumer may offer their business and therefore they are unable to recognise which consumers should be offered discounts and the level of those discounts. At best, a retailer/merchant or brand offer a loyalty card programme and the loyalty card is used when a consumer makes a purchase. The consumer usually builds up points and these can be converted and redeemed into discounts or products. The problem with these types of loyalty programmes, which are widely used by merchants, is that they only offer the merchant who offers that loyalty programme, an insight into the value that a consumer brings to their individual merchant/retailer. It does not enable the retailer/merchant to view and understand the amount of spend a consumer makes with their competitors and in other merchant categories.

In other words, retailers issue discount codes and loyalty points to customers based on the spend within their own store and not based on what that customer is spending elsewhere in the same product categories, and as a consequence, retailers loose that spend that could be switched from their competitors. The issue is compounded as retailers issue discount codes to new customers without recognising whether that consumer offers high value creation or low value creation opportunities. The result is the low value consumer is given additional discount that could be used to switch high value consumers.

Moreover, consumers do not have an understanding of their own individual purchasing power and the value they may offer to a retailer, which results in consumers paying prices that they may not be willing to pay if they were aware of the value they bring to a retailer/merchant.

The affordability of products is often unclear, and a consumer can sometimes fail to understand the financial impact of their purchases. There is no currently no mechanism in place when shopping on-line for the consumer to understand whether a product is affordable in any given time period or whether they should wait until their income allows their intended purchase to be made.

The consumer is also confronted with having to decide on the best payment option for each purchase they make with an ever increasing array of payment options at on-line merchants' checkout. The options include (1) pay by debit or credit card; (2) pay using a digital wallet using a stored credit or debit card; (3) closed loop payment system; (4) pay by instalment plan offered by multiple providers; and (5) convert points and use them toward payment.

In order for the consumer to make the right payment choice, firstly, they have to work out and understand their current financial situation and if it enables the purchase to be made and the impact that purchase has on their remaining income; secondly, they have to understand whether a debit or credit solution would be preferable; and thirdly, when they've made that credit or debit solution decision, they have to decide whether to pay by instalment plan, and whether to fund the instalment plan from a credit card or debit card.

Once all those factors have been considered, the consumer has to decide which payment provider to use, whether that be a credit card/debit card issuer; a digital wallet provider; a closed loop payment provider or a buy now pay later/instalment provider. The situation is compounded by the proliferation of buy now pay later products, where the consumer can take out numerous instalment payment plans from multiple merchants and multiple providers. The result of this is that consumers can become confused and make the wrong decisions for their situation and financial circumstances. Moreover, they may lose track of the credit payment options taken out and this can lead to serious financial consequences for consumers.

The present disclosure addresses these problems.

The present disclosure includes at least the following aspects; these aspects may each be implemented in a single click, e.g. using the aforesaid apparatus and/or system:
1. “Score, Discount & Pay” /Personalised Price & Pay”: Consumer is “scored” to determine level of discount and discount code is generated. Discount code and payment data are injected into merchants' shopping carts or sent to merchants' server without the consumer having to view or enter discount codes or payment data. The consumer is able to able to obtain and apply a discount and simultaneously make a payment with one single action touch of a screen, click of a mouse button, voice command, keyboard stroke or biometrics etc.

The discount codes can be generated and injected in shopping carts and checkout systems in real time that respond to consumers' purchasing behaviours and financial situation. The single action “Score, Discount/Personalised Price & Pay” can be used both on line and in physical merchants' stores.

The discount codes can be created in advance and stored ready for use or generated and applied in real time depending on the preferred configuration of the merchant.
2. “Connect, Discount & Pay”: Same process as Discount & Pay except consumers can interface with their friends and promote intended purchases to them. Enables consumers to view a product within a merchants' app or website and press a button/icon (Connect, Discount/Personalised Price & Purchase) next to the item they are viewing and can (a) share their product view with friends/family and message within the group for opinion on the product; (b) influence others to join them in the purchase for a greater product discount (group discount); (c) connect other purchases from different merchants for greater discount and places purchases into one payment plan. One click enables products to be promoted to contact lists, obtain a greater discount and make payment.
3. “Personalise, Discount & Pay”: Using the Dynamic Discount Code & Payment Manager to store a consumers' preferences and measurements for purchases, it injects the required personalisation options in merchants' apps or websites without the consumer having to view or enter those preferences. Such preferences could be waist size, leg size, shoe size, preferred colours, textures, materials, and food types. Thus, the consumer can select products that require personalisation such as clothing and purchase them with a discount with one click.
4. “Affordability, Discount & Pay”: Affordability assessment is performed on intended purchases and with one click the system can ensure that only products that are affordable for a particular consumer are purchased and a discount applied.
5. “Reward & Pay”: One click Reward & Pay Enables consumers to redeem any points and convert the value of those points into a discount code which can be injected simultaneously with the payment method. The consumer can also be awarded points for their intended purchase based on their CPPS. These points can either be redeemed as part of the intended purchase or following the purchase. The points can then be redeemed using Reward & Pay, whereby the points can be converted into a discount code. The discount code would then be applied in the same manner as is used with Discount/Personalised Pricing and Pay.
6. “Pay & Cashback”: Using the CPPS, one click Pay & Cashback enables consumers to make their purchase in full and then once the payment is completed, the consumer gets a rebate in the form of cashback into the DDCPM's wallet or current account. The functionality can also be used to apply cashback gained from previous purchases to new purchases. The result is the consumer gets a discount and makes payment with one click.
7. “Search, Discount & Pay”: Consumer can enter a product term(s) in the system's product search engine, which connects to a market place of merchants and obtain the best discounts and make a payment with one click Search, Discount & Pay. The functionality can be used for single or multiple products and can be used for a volume discount.
8. “Search, Time, Discount & Pay”: Same process as Search, Discount & Pay except that the consumer can time their intended purchases to match with other consumers that want the same product and purchase at the optimum time to enable a bulk order and therefore a greater product discount with one click.
9. “Impact, Discount & Pay”: Same process as Search, Discount & Pay or Discount & Pay in that it only enables consumers to obtain a discount and make payment on the products that have the least impact to the environment with one click.
10. “Search, Net Promoter Score Rate, Discount & Pay”: Same as Search, Discount & Pay except it only returns product results based on the highest Net Promoter Score ratings. This enables consumers to find the best products with the best discount and make a payment with one click.
11. “Search, Net Promoter Score Rate, Promote, Discount & Pay”: Same as Search, Net Promoter Score Rate, Discount & Pay except it enables the consumer to send the product results to their contacts list to request their friends etc consider purchasing the same product for a greater discount with one click.
12. “Discount & Apply”: This can be used within a financial services application environment, where instead of obtaining a discount and making a payment, the consumer can obtain the best interest rates or credit durations and apply for those products with one click. It uses the Consumer Purchasing Power Score to enable lenders to offer the optimum product construct.
13. “Discount & Instalment Pay”: This is similar to Discount & Pay except that the payment is an instalment rather than the full payment. Where the consumer selects Discount & Instalment, their discount is applied and an instalment is set up to take an agreed number of monthly payments to clear the balance. This could be over any pre-determined time period.
14. “Score”: Instead of “Score, Discount & Pay”, the functionality can be split out to simply allow the consumer to perform a single action one click and obtain their Consumer Purchase Power Score. This can be for an individual consumer or a cohort of consumers.
15. “Personalised Price/Discount”: Instead of “Score, Discount & Pay”, the functionality can be split out to simply allow the consumer to perform a single action one click and obtain their personalised price or discount which is based on the Consumer Purchase Power Score. This can be for an individual consumer or a cohort of consumers.
16. “Request For Discount & Payment”: The system enables consumers to purchase in physical stores using discount & pay. The merchants point of sale system sends a request to the client device to validate the discount and request the payment and the consumer is able to obtain a discount and make a payment with one click or touch etc.

Aspects of the invention also include:
17. Consumer Purchasing Power Score (CPPS): Score that enables consumers to understand how valuable they are as a consumer to merchants. It illustrates the consumers' individual purchasing power and therefore, the discounts they might expect from merchants and other providers. It uses a consumer's financial data, Open Banking data, product searches, social network mentions and product receipt data to calculate their purchasing power score.

The score continuously updates in real time to reflect a consumers' purchasing and financial behaviours, including income and expenditure. Moreover, the CPPS can be segmented according to merchant categories, brands purchased, products purchased etc. This means that a merchant for example, can segment high scoring consumers in the brands and products they sell.
18. Merchant Value Scorecard (MVS): This is a scorecard that enables organisations such as merchants to determine the level of discounts or specific pricing they want to offer to consumers with certain purchase power scores. The single action discount & pay functions use the scorecards to check the discount or price eligibility to inject into merchants' checkout systems or servers.
19. Dynamic Discount Code & Payment Manager (DDCPM): A combined digital wallet and discount code/personalised pricing generator and applicator called the “Dynamic Discount Code & Payment Manager” (DDCPM). The DDCPM generates and stores discount codes which it then injects into the discount code field in merchants' checkout systems or personalised pricing into merchants' servers. It then injects the consumers' stored payment data into the payment fields or sends tokenised payment data to the merchants' server. It is able to inject discount codes and payment data with a single action one click of a mouse button, touch screen (or other mechanisms—e.g. biometrics) using the discount & pay functions described. The DDCPM can also be used to automatically login to consumers' merchants' accounts using the customer's authentication keys, whereby the consumers' Account ID can be used to render personalised pricing.
20. Personalised Discounts & Pricing Created In Real Time Based On & Responding To Real Time Consumer Purchasing Power Score: The system uses the Consumers' Purchasing Power Score and the Merchant Value Scorecard to produce discounts & pricing in real time that are specific to an individual consumer. The discount & pricing can continuously update in real time based on the Consumer Purchase Power Score.
21. Real Time Personalised Discount & Pricing Converted To Discount Codes In Real Time & Injected/Communicated From Client Device & Applied To Server In Real Time: The system converts the discounts and pricing that is generated in real time into discount codes and it injects/communicates those discount codes into the merchants' shopping cart, checkout system or any other server application in real time.

Depending on the systems configuration, the discount codes are then applied either via the following options: (1) the single action discount & pay function; (2) opening a merchants' mobile application or visiting a merchants' website; (3) viewing products on a mobile app or website: (4) searching products on a mobile app or website; (5) voice command search for a product (6) adding products to a shopping cart; (7) hover over a product with a mouse pointer or similar device.

Option 1, the single action discount & pay is used when the consumer has decided that they want to purchase a product(s), and this injects/communicates the discount in real time with the payment with one click of a mouse button, touch screen, voice command, keyboard stroke, biometric action etc. Options 2, 3, 4, 5 and 6 are used in advance of the consumer deciding on a product, whereby the discount codes are sent to the server or injected into a checkout system and ready to use should the consumer decide to purchase any of the products they have interacted with.

Using options 2, 3, 4, 5 and 6, either separately or combined, the consumer can simply select to pay with one click and the discount is already applied thereby enabling a one click discount and pay as an alternative method to option 1 that injects/communicates the discount and payment together to enable the consumer to purchase with one click single action discount & pay. That is to say option 1 sends the discount & payment once the consumer has clicked the option discount & pay, whereas all other options send the discount to the server in advance, and the consumer then selects checkout to apply the pre-filled discounts and make payment. All options result in a one click to obtain a score, a personalised discount/price and make a payment.

The system can be configured to use real time or non-real time depending on the preferences of the merchant. Where the term merchant is used this can also be applied to any business or organisation and not just a retailer.
22. Real Time Personalised Discounts & Pricing Converted To A Server Message/Instruction In Real Time & Applied In Real Time The system converts real time personalised discounts and pricing to a server message/instruction in real time. This is used as an alternative to using discount codes as described in embodiment 5 above. All the systems configuration and options described in embodiment 20 are also applicable to this embodiment.
23. Volume Discount Using Product Search Engine: The system has its own search engine that connects to a marketplace of merchants. Search engine uses the Consumers' Purchasing Power Score to enable consumers to search for single or multiple products. The search engine produces results that not only show the products and price available but also the personalised unique discount for the consumer based on the consumers' individual purchasing power score and/or the number of other consumers that want the same or similar product. The consumer can then purchase the products displayed from the search engine results using single action one click volume discount and pay.
24. Personalised Pricing: The system can be configured to provide pricing that is unique to an individual or cohort of consumers. Instead of using discount codes to adjust pricing, the system interfaces with the merchants' server to reduce pricing based on the Consumers' Purchasing Power Score.
25. Retrospective Discount: Merchants can view consumers' recent purchases from their competitors and can offer a discount using the Consumers' Purchasing Power Score and price paid. The consumer can then decide to accept or reject the offer and use the discount and pay function to purchase the product and obtain a better discount from what they had previously paid.
26. Gift Discount Codes: Consumers can purchase gift discounts to send to others. Participating merchants can view the size of the gift and consider whether they want to increase the gift amount to persuade the consumer to spend their gift at their store using one click discount and pay.
27. Affordability Assessment: Enables consumers to understand whether a specific product or a basket of products is affordable by using the consumers' Open Banking data. An indicator is presented displaying the affordability status of their chosen products or products they are viewing.
28. Personalisation: The Dynamic Discount Code & Payment Manager can store the consumer's own size measurements and preferences such as colour and textures that can then be used to inject into the merchants' options fields such as shoe size, waist size, preferred colour without the consumer having to view or enter that information. The personalisation option could be extended to allow personalisation of products such as food/drink flavours etc. The system can be configured to allow the consumer to store any personalisation preference. It can be integrated with single action discount and pay, to form single action “Personalise, Discount & Pay” that injects measurements, colour etc, discount codes and payment data with one single action mouse click/touch screen/voice command/keyboard stroke/biometrics etc.
29. Universal Shopping Cart & Checkout System: The single action functions and embodiments described can all be used within a shopping cart system. Products from different participating merchants can be added to the shopping cart and the consumer can view all of their intended purchases, view affordability statuses of products, interact with their friends/family to promote the products and encourage others to purchase for a bulk discount, switch their service providers such as energy for a cashback contribution to their purchase costs, and view/accept real time payment bids from lenders. The consumer can then use any of the single action discount and pay functions for one click checkout.
30. Real Time Bank Bidding For Individual Purchase Transactions: Enables banks/lenders to bid to be the payment provider for consumers' individual intended purchases. Consumers can view bids or enable the system to decide the optimum bid and payment choice for their intended purchases.
31. Personalised Illustration Of Discount/Price: The Consumers' Purchase Power Score is used to present a real time discount or price of product(s) when the consumer performs any of the following actions: (1) opens a merchants' app or visits a merchants' website; (2) hover over a product with a mouse, touch screen, pointer or similar device; (3) click on a product to view the product details; (4) search results for products when entering a search term in a search engine; (5) add product(s) to a cart; (6) select discount & pay; (7) any other method of checkout
32. Request For Discount & Payment: The system enables consumers to purchase in physical stores using discount & pay. The merchants point of sale system sends a request to the client device to validate the discount and request the payment and the consumer is able to obtain a discount and make a payment with one click or touch etc.

These functions may be carried out on any combination of devices, in particular:
1. Merchants' Mobile Apps & Websites:
   Discount & Pay.
   Discount & Instalment.
   I Connect, Discount & Pay.
   I Personalise, Discount & Pay.
   -Affordability, Discount & Pay.
   Reward & Pay.
   Pay & Cashback.
   Impact, Discount & Pay.
2. Systems' Own Product Search Engine:
   Search, Discount & Pay.
   Search, Time, Discount & Pay.
   Impact, Discount & Pay.
   Search, Net Promoter Score Rate, Discount & Pay.
   Search, Net Promoter Score Rate, Promote, Discount & Pay.
   Personalise, Discount & Pay.
3. Shopping Cart & Checkout System:
   The single action functions can be used independently to avoid the need for a shopping cart by checking out with one click using any of the single action functions. However, where consumers want to review intended purchases in a shopping cart, all single action functions described in any combination and any sequences can be used within a shopping cart and checkout system.
4. Physical Merchants' Stores:
   Discount & Pay.
   Discount & Instalment.
   Connect, Discount & Pay.
   Affordability, Discount & Pay.
5. Financial Services Consumer Product Applications
   Discount & Apply.

Each and every one of the single action functionalities described can be broken down into two or more clicks, touching of a screen etc to obtain the same outcome. For example, “Score, Discount & Pay” can be performed using multiple clicks, touching of a screen etc to obtain a Consumer Purchase Power Score, obtain a personalised price or discount and simultaneously make a payment.

Multiple clicks can be used in a scenario where for example a merchant wants to introduce more steps to offer the consumer a personalised price based on their Consumer Purchase Power Score and to make a payment.

Any feature described as being carried out by an apparatus, an application, and a device may be carried out by any of an apparatus, an application, or a device. Where multiple apparatuses are described, each apparatus may be located on a single device.

Any feature in one aspect of the disclosure may be applied to other aspects of the invention, in any appropriate combination. In particular, method aspects may be applied to apparatus aspects, and vice versa.

Furthermore, features implemented in hardware may be implemented in software, and vice versa. Any reference to software and hardware features herein should be construed accordingly.

Any apparatus feature as described herein may also be provided as a method feature, and vice versa. As used herein, means plus function features may be expressed alternatively in terms of their corresponding structure, such as a suitably programmed processor and associated memory.

It should also be appreciated that particular combinations of the various features described and defined in any aspects of the disclosure can be implemented and/or supplied and/or used independently.

The disclosure extends to methods and/or apparatus substantially as herein described with reference to the accompanying drawings.

The disclosure will now be described, by way of example, with reference to the accompanying drawings.

In this description:
DDCPM typically refers to a Dynamic Discount Code & Payment Manager.
MVS typically refers to a Merchant Value Scorecard.
CPPS typically refers to a Consumer Purchasing Power Score.
RFDP typically refers to a Request for Discount Validation & Payment.

The disclosure herein seeks to increase the competition for consumer and business payments and address the lack of transparency in the optimum option available when sending and receiving payments. Moreover, it also helps to increase the switching market for financial products including current accounts, which is a key priority for regulators. Today, a consumer or business (SME/Corporate) will open a debit and/or credit account with one or more providers and the consumer/business will then use that account(s) to make purchases, send and receive payments. The problem with this model is that once the provider has acquired the customer, it can generally rely on the customer using that account for some or all of their financial transactions, which means the consumer or business does not always receive the best option for sending or receiving individual payments and transactions. That is to say the payment schemes, banks, credit card issuers and others don't have to compete as hard for the customer unlike they would if every single payment and financial transaction was competed for. The competition for every individual payment, bank transfer, foreign currency purchases et al would increase transparency on interest rates, durations, rewards etc on individual transactions and the consumer or business would greatly benefit from more competition for their individual payments and financial transactions.

The opportunity therefore, is to develop a solution that enables both consumers and small and large businesses to use an application that enables every single purchase to be competed on for the payment/balance; every individual bank transfer to be competed on for the balance, every foreign currency purchase and foreign currency bank transfer to be competed on, every salary payment to be competed on. The system ensures that every single individual financial transaction or payment receives the best market rate and terms before it is deposited into an account only later to have to be switched out for a better deal. It also means every purchase, if on credit is given the best credit terms for that transaction balance and if on debit, the sending account competes to retain the balance or acquire more payment transactions depending on the strategy of the Financial Institution. Every payment made is in effect, simply a balance, whether micro, small or large and every individual balance can be competed on within a business to business marketplace for greater competition with material benefits to consumers and businesses.

The solution is to utilise the consumer and business scoring system previously described consisting of purchase power, financial power, consumption power, creation power, and business power to inform the customer and financial institutions of the value that each individual transaction could represent to the bank/lender/payment scheme. If financial institutions can understand the likely profitability of a specific individual transaction from a given consumer or business then they can make informed decisions as to how valuable a specific transaction is to their financial institution and make bids accordingly for individual transactions.

This is made possible by inserting the purchase power, financial power, consumption power, creation power, and business power scores into any payment message. Any single or combination of scores can be used within a payment message. The payment messages can include card payment scheme messages such as Mastercard, VISA etc and also bank transfer payment messages such as SWIFT, Faster Payments (Real Time Payments) etc. Payment messages can be localised within specific countries and/or global. In addition, a new payment message standard could be specifically created to insert the consumer and business power scores with the payment. The system could also use a separate messaging system to the payment, but the result would be the same, whereby a message containing a score to determine a consumers' or businesses' profitability is established when performing a payment or financial transaction.

The payment message is then sent simultaneously to multiple participating financial institutions, whereby the receiving financial institution can ingest the payment data including the consumer power and business power scores and respond with a decision on (a) do they want to bid for the payment/financial transaction and (b) what their bid is to obtain that payment/financial transaction. The successful bid is then authorised by the system and is presented to the customer within a single view. That is to say, the customer will be able to view all of their transactions or balances from different providers in one simple view. Over a pre-determined time, the individual transactions can be consolidated and offered to the business to business financial institution marketplace for bidding. That bid can be done in real time via an API call or it can be processed via an auction in real time or in batches of payments.

The scores within a payment message or message standard and schema can be used for retail purchases (on line and in store), retail and commercial bank payment transfers, salary payments, foreign currency purchases, foreign currency bank transfers and any financial transaction. This means that every financial transaction in any country can be bid on by market participants in real time, via batch and or by auction. Consumers and businesses can also view in real time banks, payment schemes, issuers, fintechs and any other organisation bid on their individual transaction and each transaction that is successfully bid on is presented in one single view on the system's application. This can be applied for real time payment bids and real time auctions or any delayed payment batches or payment auctions. The system significantly improves the transparency for consumers and businesses when making, sending and/or receiving financial transactions and means that they will get the best financial outcomes for their given financial circumstances at a specific point in time. The system can also move transactions retrospectively, whereby if a consumer is not a customer of a particular bank or financial institution, the consumer can allow other banks to view the transaction and score and enable a counter bid to be made.

In essence, the system enables any score that represents an individual, a cohort of individuals, a business and/or a cohort of businesses to be inserted into a payment message or sent as a separate message if required with the intention of an individual payment or batch of payments being sent to a marketplace of multiple financial institutions to be bid on by each financial institution and the system decides which financial institution has been successful in its bid for the individual payment or financial transaction or a batch of payments or financial transactions. The payment becomes a balance which can then be used on a credit basis that could revolve over a period of time or specific duration to pay down or alternatively it can become a deposit or savings balance that can earn interest and depending on the consumers' financial situation, the system works out the best option and sends out bid requests for either credit or savings options on a specific payment/balance. The invention provides for any score inserted into a payment message or message that enables a Financial Institution or other participating organisation to understand how valuable or profitable an individual payment transaction sent or received by a consumer or business is likely to be and that allows a bid to be placed to ‘win’ the financial transaction or payment transaction and that applies for purchases, bank transfers and foreign currency transfers, whether using the system's own payment schema or any other payment schema domestically or globally.

### DESCRIPTION OF THE DRAWINGS

FIG. 1a shows a system on which the methods disclosed herein may be implemented.

FIG. 1b shows an apparatus on which modules of the system of FIG. 1a may be implemented.

FIG. 2 shows a method of determining a Consumer Purchasing Power Score (CPPS).

FIG. 3 shows a method of completing a transaction based on the disclosures.

FIG. 4 shows a method of transmitting a discount code associated with a user.

FIG. 5 shows a detailed method of generating dynamic discount codes.

FIG. 6 shows a method of generating a discount for a volume purchase.

FIG. 7 shows a method of generating a retrospective discount.

FIG. 8 shows a method of an individual consumer obtaining bulk buy discounts.

FIG. 9 shows a method of providing a gift code to a user.

FIG. 10 shows a method of agreeing a monthly payment plan with a user.

FIG. 11 shows a method of agreeing a bid on a transaction with a user.

FIG. 12 shows a method of transmitting a transaction comprising personalisation information.

FIG. 13 shows a method of buffering transaction requests to obtain a bulk discount.

FIG. 14 shows a method of completing transactions associated with a plurality of merchants.

FIG. 15 shows a system architecture for the generation of consumer and business scores.

FIG. 16 shows a process for generating and inserting the consumer or business scores into a transaction.

FIG. 17 shows a process for generating, receiving and presenting an individual payment or financial transaction or batch of payment or financial transactions.

FIG. 18 shows a process for generating a Financial Power Score.

FIG. 19 shows a process for generating a Foreign Currency Power Score.

FIG. 20 shows a process for generating and applying a gaming power score.

FIG. 21 shows a process for generating and applying a trading power score.

FIG. 22 shows a process for generating and applying a single action one click/touch Create, Pay & Sell.

### DETAILED DESCRIPTION

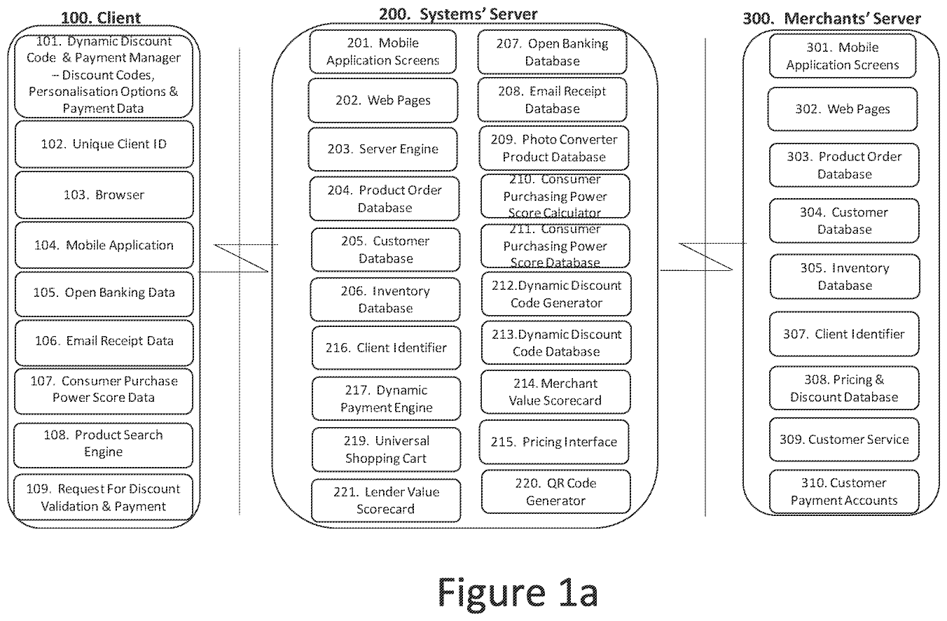

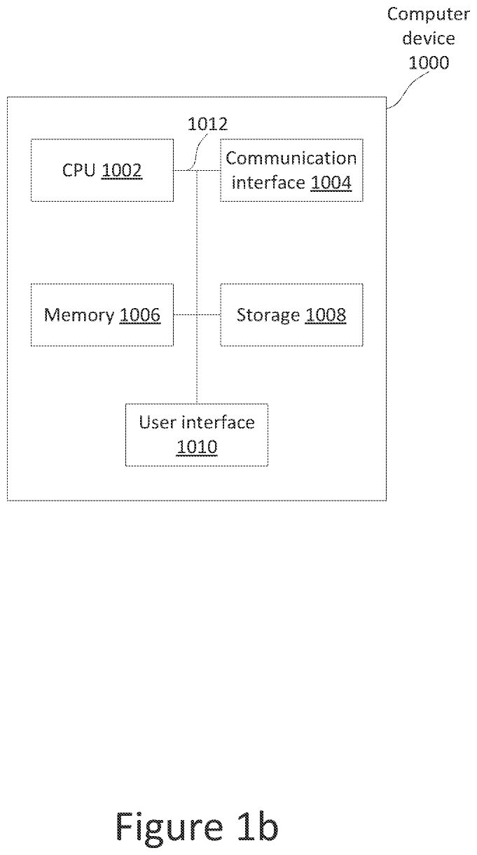

FIG. 1a illustrates a system on which the methods disclosed herein may be implemented. The modules of this system are typically implemented on a client device 100, a system server 200, and a merchant server 300. The modules within the client device include a Dynamic Discount Code & Payment Manager (DDCPM) 101, which is an application that the consumer downloads to the client device and is used to generate, store and inject discount codes and apply payment information within merchants' on-line checkout journey.

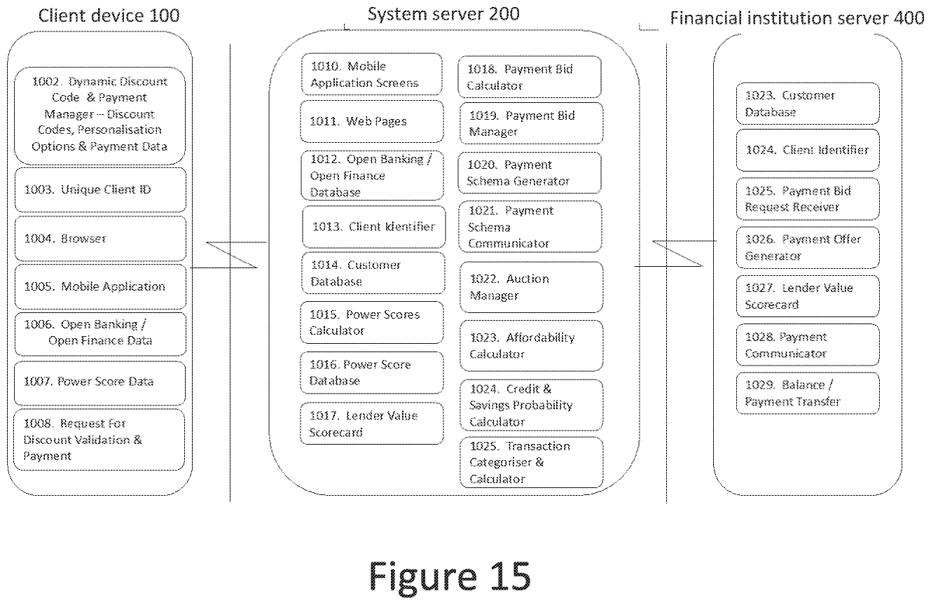

It will be appreciated that the various methods and systems herein may be implemented using the modules of FIG. 1a, but also that other configurations are possible (e.g. as shown in FIG. 15). For example, fewer modules, or other modules, may be used to implement certain methods and systems disclosed herein.

The DDCPM 101 enables single action discount code generation, application and payment to happen with one click of a mouse button, single touch of a screen or voice command by injecting a discount code into discount code field and payment data into the payment data field without the consumer having to view or enter discount codes or payment data. The system can also be configured to send an instruction to a server containing discount and tokenised payment data. Either option of injection or sending a message to the server means that a merchant can actually remove the visible discount code, payment fields, billing and shipping fields from their checkout journey within apps or websites and replace it with a single action one click discount code and payment button.

The Unique Client ID 102 provides an identifier that is unique to that client device which enables the system to identify the source of the messages and/or to associate a client or a device with a determined score. The server device 200 and the client device 100 interact via APIs (application program interfaces) over the internet. The Browser 103 and Mobile Application 104 enable the server to present information to the client device and to recognise when the client device has an active merchants' application or website open, which can then enable dynamic discount codes to be generated in real time.

The Open Banking data 105 is shared between the by client device 100 and the server 200. Email accounts 106 are shared by client device with server to access email purchase receipt data. Receipt data can also be taken direct from merchants' server. The Open Banking data, social media mentions, product searches and receipt data may be used to calculate the Consumer Purchase Power Score (CPPS). The CPPS score may then be communicated by the system server to the client device and can be stored on client device.

The system server 200 uses a server engine 203 to receive data from the client device to perform a calculation to produce a Consumer Purchase Power Score. The system then generates unique discount codes, along with the mechanisms to correctly allocate those discount codes to specific merchants and client IDs and to insert the payment data to the relevant merchants' payment fields or send tokenised payment details to the merchant's payment processor.

The mobile application screens 201 and web pages 202 enable the server to present information to the client device in the form of webpages and mobile application screens. The client ID 216 identifies the specific client ID that is used to map the correct messages and communication exchanges for that client ID when communicating between server and client device. The Open Banking database 207 enables the Open Banking data received by client device to be stored and mapped to the correct client ID. The email receipt database 208 receives email receipts and identifies and stores purchases made by consumer. The photo converter product database 209 recognises photos/screenshots of products and converts them into product searches and order requests.

The Consumer Purchase Power Score Calculator 210 enables the server to calculate the score attributable to a particular consumer and client ID and the Consumer Purchasing Power Score Database 211 stores the Consumer Purchase Power Scores (CPPS) which are identifiable by the client ID. The Dynamic Discount Code Generator 212 generates discount codes based on the CPPS and the Merchant Scorecard 214. The Merchant Scorecard holds the discount percentages that consumers with specific CPPS are eligible for.

The Dynamic Discount Code Database 213 stores the discount codes and sends them to the DDCPM on client device. The pricing interface 215 allows the server to present personalised pricing rather than using discount codes to the client device based on the CPPS. The Product Order Database 204 is the product order database that holds the orders that the consumer has made from their client device and communicates with the inventory database 206 to validate product availability and to confirm the product order.

The customer database 205 holds the details of individual customers and consumers with product searches, views, potential orders and orders. The dynamic payment engine 217 enables the best payment type to be used for different purchases and also enables lenders to compete in real time for individual transactions.

The merchants' server 300 can be used if the merchant prefers to carry out some of the processes described above themselves rather than using the system's own server. It is expected that the merchant will use the system's server to carry out the majority of actions and processes described above on behalf of themselves and their customers. The system can be configured to operate the processes on behalf of a merchant or send data to a merchants' server, in order for the merchant to perform the processes.

Each of the applications described above is typically implemented using a computer device, wherein the applications may be implemented using a processor of the computer device. Each of the client device 100, the system server 200, and the merchant server 300 may be implemented on a separate computer device. Equally, two or more of these systems may be implemented on a single computer device.

It will be appreciated that systems with only a subset of the modules described above may be used to implement the methods of the present disclosure.

Referring to FIG. 1b, there is shown an exemplary computer device on which the client device 100, the system server 200, and/or the merchant server 300 may be implemented.

Each computer device 1000 typically comprises a processor in the form of a CPU 1002, a communication interface 1004, a memory 1006, storage 1008, and a user interface 1010 coupled to one another by a bus 1012. The CPU 1002 executes instructions, including instructions stored in the memory 1006 and/or the storage 1008.

The communication interface 1004 is arranged to enable the computer device 1000 to communicate with other computer devices (e.g. to enable the system server 200 to communicate with the client device 100 and/or the merchant server 300. The communication interface may comprise one or more of: an Ethernet network adaptor; an area network interface, an infrared interface, and/or Bluetooth®.

The memory 1006 stores instructions and other information for use by the CPU 1002. The memory is the main memory of the computer device 1000. It usually comprises both Random Access Memory (RAM) and Read Only Memory (ROM).

The storage 1008 provides mass storage for the computer device 1000. In different implementations, the storage is an integral storage device in the form of a hard disk device, a flash memory or some other similar solid state memory device, or an array of such devices.

The user interface 1010 enables a user to interact with the computer device 1000 and typically comprises a display and an input/output device, such as a keyboard and a mouse.

A computer program product is provided that includes instructions for carrying out aspects of the method(s) described below. The computer program product may be stored, at different stages, in the memory 1006 and the storage 1008. The storage of the computer program product is non-transitory, except when instructions included in the computer program product are being executed by the CPU 1002, in which case the instructions are sometimes stored temporarily in the CPU or memory. The computer program product may be held separately from the computer device from time to time, e.g. on a removable storage. Different computer program products, or different aspects of a single overall computer program product, are present on the computer devices used for the client device 100, the system server 200, and the merchant server 300.

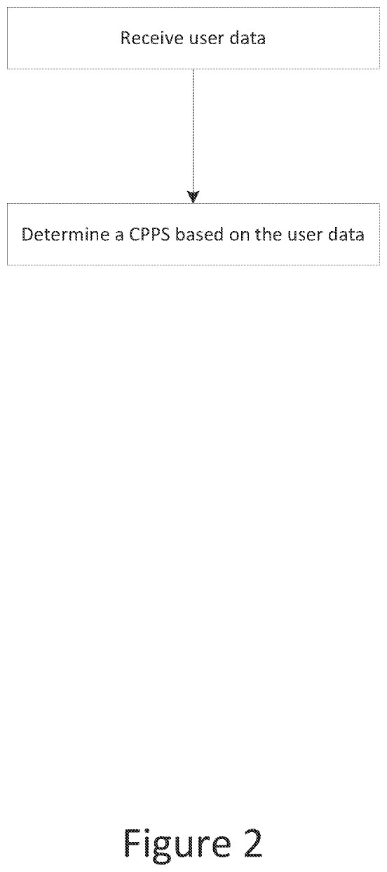

Referring to FIG. 2, there is described a method of determining a Consumer Purchasing Power Score (CPPS). The use of a standard purchase power scoring system enables consumers to not only understand their own purchasing power but also to obtain personalised products, discounts and pricing.

This method is typically carried out by one or more of: a computer device 1000; the client device 200; and the system server 200.

In a first step, the computer device receives user data from the Open Banking Data module 105. The computer device may also receive other data relating to the user, such as email data, user preferences, user characteristics, etc.

In a second step, the computer device determines the CPPS based on the user data.

This score enables merchants to quickly determine a consumers' value to a merchant irrespective of the country they live in.

The system is able to harmonise the data from the different Open Banking regimes to create a single standard value that represents a consumers' purchasing behaviour and purchasing power irrespective of the country they live in. The metric known as the “Consumer Purchasing Power Score” (CPPS) will move in tandem with the consumers' purchasing and financial behaviour, which can then be used to identify low, medium and high value consumers based on a score of 0-999, with 0 being the least value and 999 offering the most value to a merchant.

The CPPS can be broken down into specific merchant categories that detail a consumers' spend and value in specific Merchant Category Codes.

The Consumer Purchasing Power Score is produced by the consumer downloading the Discount Code & Payment Manager 101 onto a client device 100. Client device gives permission to access Open Banking data and product receipt data. Server uses Open Banking data to identify merchants and purchase prices. The DDCPM may also extract email receipts on client device and identifies merchants, products and brands purchased with associated purchase prices. Using Open Banking data, receipt Data and product searches, the server is able to calculate a score of the value of individual consumers known as the “Consumer Purchasing Power Score” (CPPS) 210 and the score is then stored in the Consumer Purchasing Power Database 211.

The CPPS can be used alongside a scorecard that a merchant inputs into to assign importance and value for particular product categories. This will be known as the “Merchant Value Scorecard” (MVS). The MVS will contain for example, percentage discounts for consumers in particular CPPS bandings that can determine what discounts could be offered on specific products, a range of products or all products. For example, a health and beauty merchant may want to attract consumers that have a high spend and a high frequency of spend in health and beauty products and in their MVS can assign the highest level of discounts to those consumers that have a high value of spend in the health and beauty category but currently spend it with a competitor merchant, the discount can then encourage them to switch merchant and brands.

In other words, in order to determine a discount for a specific good, the computer device may determine a CPPS and a MVS and determine the purchase based on these factors.

The discount Code Generator 212 on the system server 200 communicates with the DDCPM 101 on the client device 100 and sends discount codes that are stored on DDCPM for use within merchants' apps and websites. DDCPM interfaces with merchants' server 300 and the communications link between the DDCPM, system server and merchants' server recognises product views by consumers on merchants' apps and websites and can generate dynamic discount codes if required. DDCPM injects discount codes and payment information into discount code field and payment fields or sends tokenised payment data to merchant's payment processor without the consumer having to view or enter any discount code or payment data. Open Banking data confirms when a retail purchase is made. Consumer Purchasing Power Score Database is then updated on server. Server provides an updated Consumer Purchasing Power Score to Merchants Value Scorecard on server. Merchant Value Scorecard communicates with Discount Code Generator and Discount Code Generator provides new dynamic discount codes to DDCPM on client device.

When the consumer performs the single action “discount and pay” by pressing an icon next to a product on a merchants' app and website, the client system communicates this to the server system. The server system adds the product details and discount/price to the unique client ID, communicates this data with the DDCPM on the client device with an instruction for the DDCPM to inject the discount code into the discount code field and payment data into the payment fields or sends tokenised payment data to processor. The DDCPM on client device notifies the server to complete the purchase. The server communicates with client device and the DDCPM presents confirmation of discount, price and payment. The DDCPM on client device communicates with server and updates the Consumer Purchasing Power Score database 211.

The Consumer Purchasing Power Score database communicates with the Merchant Value Scorecard 214 to obtain the qualifying discounts based on the Consumer Purchasing Power Score for a specific client ID. The discounts mapped to client ID are sent to the Dynamic Discount Code Generator 212 and updates the Dynamic Discount Code Database 213. The server communicates the updated dynamic discount codes with the DDCPM on client device 101. The DDCPM stores the new dynamic discount codes that will be used to inject on merchants' apps and websites when they are active on client device.

The CPPS is utilised as a basis to generate dynamic discount codes, and given that the CPPS operates in real time, this means that merchants can provide consumers with dynamic discounts and discount codes to encourage purchasing of a basket of products or specific products, and the computer implemented system can inject those discount codes in merchants' shopping carts without the consumer having to find or view a discount code.

The present disclosure enables the following four actions to occur with one single action mouse click, single touch of a screen, voice command, biometrics etc in a client/server environment: (1) a purchasing power score for an individual consumer to be generated and shared, (2) discounts and discount codes to be generated and applied or a client ID with a message to merchants' server to amend pricing using the purchasing power score as a basis to qualify a consumer for discounts/personalised pricing; (3) contact and shipping details entered; and (4) a payment applied and checkout completed.

These four actions may be implemented using the Dynamic Discount Code & Payment Manager (DDCPM) 101. The creation, storage and application of the discount codes and payment data occurs in the DDCPM on the client device, or a server can send the data to the DDCPM depending on the chosen system configuration. The DDCPM uses a scorecard, called the “Merchant Value Scorecard” from each merchant to determine the level of discount a consumer qualifies for. These discounts are then converted into discount codes ready for the DDCPM to inject into merchants' checkout systems or server environment.

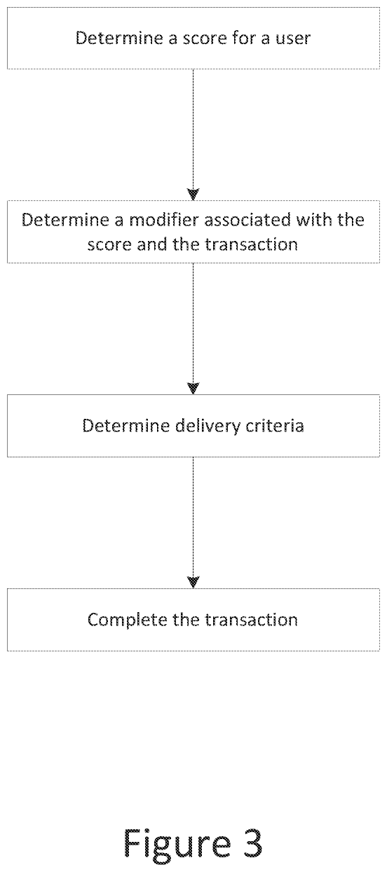

Referring to FIG. 3, there is described a method of completing a transaction based on the disclosures herein. This method is typically carried out by one or more of: a computer device; the client device 100; the system server 200; and the merchant server 300.

The method of FIG. 3 is initiated by a user transmitting a transaction request.

In a first step, a computer device (e.g. the client device 100 or the system server 200) determines a score for a user (e.g. the CPPS). This score may be generated before the transaction request has occurred, so that the determination of the score may comprise the score being transmitted form the client device 100 and/or the system server 200 to the merchant device 300.

In a second step, a computer device (e.g. the client device 100 and/or the system server 200) determines a modifier (e.g. a discount) associated with the score and the transaction. Typically, the modifier is dependent on one or more of: a merchant value score (MVS); a good and/or a party associated with the transaction; and a context of the transaction (e.g. a time of, place of, or reason for the transaction).

While the modifier is typically a discount, the modifier may also be an increase in price (e.g. where a user has a particularly low score) Yet more generally, the modifier may comprise other modifiers to the transaction request that are associated with a user (e.g. a modification of a payment date, or of a characteristic of a good associated with the transaction request).

In a third step, a computer device (e.g. the client device 100 and/or the system server 200) determines delivery criteria for the transaction, such as shipping and/or contact details for the user. Where the transaction relates to an online good, the delivery criteria may be an email address. Typically, the delivery criteria are stored on one of the devices, for example the delivery criteria may be stored in the customer database 205 on the system server 200.

In a fourth step, a computer device (e.g. the merchant server 300) completes the transaction. This may comprise the client device 100 and/or the system server 200 transmitting the parameters of the transaction (e.g. the good, the modifier, the score, and the delivery criteria) to the merchant server 300.

Typically, the first step of the determination of the score happens on the client device 100 and/or the system server 200. The score is then transmitted to the system server 200 and/or the merchant server 300.

Typically, the second step of the determination of the modifier happens on the client device 100, the system server 200 and/or the merchant server 300. The modifier may then be transmitted to the merchant server.

Therefore, there is disclosed a method of transmitting a first signal comprising a score on a client device and/or a system device, transmitting this first signal to the system device and/or a merchant device, determining a second signal comprising a modifier based on the first signal, transmitting the second signal to the merchant device (if necessary) and completing a transaction using the first signal.

The determination of the score on the client device 100 and/or the system server 200 leads to an increase in security, since this enables a personalised discount to be determined without requiring the merchant server to access the clients information and holdings.

The score may comprise one or more of:
1. A purchase power score (capacity to purchase in specific merchant categories and actual spend in specific categories)
2. A product consumption power score (how much does a consumer consume in particular merchant category)
3. A preference power score (consumers' individual preferences for products in specific merchant categories)
4. A financial power score (capacity and utilisation of credit and savings balances)
5. A foreign currency power score (frequency and value of foreign currency purchases/payments)
6. A betting & gaming power score (how often does a consumer place bets and what is the amount of their deposits and withdrawals
7. A stock trading power score (how often does a consumer purchase equities or other asset classes, what is the price paid and what is the price sold at, what fees are charged and what profit is made)
8. A creation power score (how often does a consumer produce/sell their own products)
9. A health, fitness & medical power score (fitness activity plus medical history)
10. A business power score (how a business uses the payments it receives, whether that be as investment into the business, expenses or retained as cash balances)

In various embodiments, the scores are:
combined with other users to super power their collective activity such as purchasing or gaming; and/or
tagged and shared with businesses in return for value; and/or
injected into payment messages to enable market participants to bid on individual transactions; and/or. injected into any other message standard to identify and reward value.

In some embodiments, the scores are used in one or more of a shopping, purchasing, banking, financial, betting, gaming, health, fitness, and/or medical environment/eco-system, whereby consumers can use their scores to view products that have been tailored to them based on their scores and simultaneously make a payment in one single action.

In some embodiments, the scores are used to modify a product, a price, a reward, a bonus, an NFT or any other form of value a business wants to provide and configure that value with a payment in one single action.

More generally, the score of a user may be used to modify a parameter of a good and/or service (e.g. a price, an ownership value, an amount of points, etc.).

The transaction may comprise, for example, a purchase transaction, a bank transfer, a foreign currency payment, or another type of (e.g. financial) transaction.

Conventionally, a merchant seeking to personalise a discount might request access to a banking application of a consumer. Understandably, a consumer would be wary about providing this access, since, if the merchant is malicious, they would be able to use this access for nefarious purposes. With the present disclosure, the consumer need not provide access to their information and holdings. In some embodiments, the score is determined on the client device, which enables the client to not share information at all. In some embodiments, the score is determined on the system server, which enables the client to trust only a single other party.

Similarly, the modifier may be determined on the merchant server so that the merchant does not have to share customer information. In this regard, the modifier may depend on the score of a consumer as compared of the scores of other consumers. The merchant may not wish to share the other scores, so may determine the modifier wholly on the merchant server. In some embodiments, the modifier is determined on the system server, which enables the merchant to trust only a single other party.

The completion of the transaction comprises the merchant server 300 determining: a good or service associated with the transaction, a modifier associated with the transaction (the modifier being associated with the score); delivery criteria (e.g. a delivery address); and a payment means. The merchant server may receive each of these parameters separately. Equally, the merchant server may receive a single request that comprises these parameters.

For example, the DDCPM 101 may be implemented as an overlay, where the DDCPM provides an overlay for a merchant application and provides the user with an ‘apply discount and pay’ button. When the user presses this button, the client device 100 may communicate with the system server 200 to determine the CCPS, the MVS, and/or the delivery criteria so that either of the client device 100 or the system server 200 is able to send a transmission to the merchant server 300 that contains all of the parameters required to complete the transaction. The merchant server is then able to simply complete the transaction. Such an implementation minimises the amount of processing required for the merchant server and enables the disclosed methods to be used without substantial modifications being made to the merchant server.

Typically, the merchant server 300 is arranged to receive the parameters and/or the score from the system server 200, since the system server may be trusted more than individual client devices.

Typically, the system server 200 is arranged to store client IDs and/or merchant IDs. This enables the system server to match a client to a CPPS and a merchant to an MVS. The method of completing a transaction may include one or more of: the system server receiving a signal from a client device, determining an identifier of the client device, and determining a score for the client based on the identifier; and the system server receiving a signal from a merchant server, determining an identifier of the merchant server, and determining a score for the merchant based on the identifier.

In a practical example of the use of this method: , a consumer downloads the DDCPM application 101 onto the client device 100. The DDCPM on the client device then communicates with the system server 200 and a unique client identifier is assigned to the DDCPM. The Client ID 102 is stored on client device as well as on a server client ID module 216. The system server maps each client identifier to a consumer that uses that specific client system to obtain a discount and make payment. DDCPM on client device instructs server to store Open Banking data 207 and Email receipts 208 on server 210 and can be stored on server 211 or sent to DDCPM on client device which stores them in the DDCPM 101. The DDCPM matches discount codes to active merchants' apps and websites on client device. When a consumer views a product on client device and wants to purchase it by selecting “Discount & Pay” as an icon next to the product, the consumer uses a client system to send the request for the product description and eligible discount with the client identifier. The server sends the requested information to the client system including the confirmation of the single action discount and pay.

The client device 100 and/or the system server 200 may be arranged to also communicate with a third party device, such as a bank server. The third party device is arranged to transmit an offer based on the score (e.g. an offer for financing). The transmissions from client device 100 and/or the system server to the merchant device may depend on this offer, where this offer may in particular comprise payment details.

In some embodiments, the system server 200 is arranged to transmit details of the good or service, the score, the modifier, and/or the context of the transaction to a plurality of third parties, to receive a return transmission from one or more of these third parties, and to transmit a signal to the client device 100 and/or the merchant server 300 in dependence on the return transmission(s). In particular, the system server may transmit a plurality of offers (e.g. of financing) to the client device, receive a transmission indicating acceptance of one of these offers, and thereafter transmit a signal indicating the accepted offer to the merchant server.

The DDCPM 101 may generate, store and/or inject discount codes and payment data that react to a purchasers' spending behaviours into merchants' apps and websites. The DDCPM may be activated when a consumer selects a single action one click Discount & Payment button or voice command, biometrics etc. The DDCPM then injects the relevant discount, billing, shipping and payment data into the merchants' checkout system or server without the consumer viewing or entering any of the required data fields themselves. That is to say, the consumer is able to simply click once for all of those processes to take place.

The DDCPM 101 is typically arranged to inject discount codes directly into merchant apps or websites. This means that a merchant can have a one click discount and pay on individual product views or basket of products. For example, if a consumer views a TV, there can be a clickable icon next to the view of the TV that asks if the consumer wants to apply their eligible discount and pay immediately, thereby removing the need for a separate presentation and input of a discount code field and a payment field.

The DDCPM is arranged for one or more of: (1) receiving Open Banking data, product receipt data, screen recordings along with other data sources; (2) generating dynamic discount codes and/or pricing; (3) storing Open Banking data, receipt data, personalisation data such as sizes, colour preferences etc, discount codes and pricing; (4) injecting discount codes and/or pricing and payment data into merchants' apps and websites or sending request to merchants' server to amend pricing based on CPPS. The client device 100 requests Open Banking data from financial services organisations using the standard national and international Open Banking framework APIs.

Depending on the configuration, the DDCPM 101 can be used to generate discount codes or the system server 200 can generate the discount codes and then send them to the DDCPM for storing and injecting. Equally, the system server may store the codes itself.

The processes disclosed herein enable a consumer to obtain a discount that is unique to them and reflects their purchasing behaviour and financial capacity to afford the item and make payment. These processes can be set up to sequentially perform each action with one click of a mouse button or voice command.

The present disclosure combines a digital wallet augmented with dynamic discount code generation and application capabilities to create the “Dynamic Discount Code & Payment Manager” (DDCPM) 101. The digital wallet can be used in the traditional format where the consumer chooses and loads the payment card(s) into the digital wallet that they wish to use for purchasing and can be set up so that when the consumer selects a product on a merchant app or website, they can choose “One Click Discount & Pay”, where the discount code is generated and applied and the payment data entered from the stored card in the DDCPM, with the consumer not having to enter or view any discount code or enter any payment information.

The DDCPM 101 is typically arranged to generate dynamic discount codes based on one or more of: (1) what the consumer is viewing on client device, (2) what the consumer may have added to a basket but not proceeded to checkout with, (3) active merchants' app and websites; (4) location. The DDCPM can also be used to interact and interface directly with merchants' apps and websites by presenting the discount to the consumer within or near the “discount & pay” icon. Using the Consumers' Purchase Power Score, the system can present a real time discount or price of product(s) when the consumer performs any of the following actions: (1) opens a merchants' app or visits a merchants' website; (2) hovers over a product with a mouse, touch of a screen, pointer or similar device; (3) clicks on a product to view the product details; (4) search results for products when entering a search term in a search engine; (5) adds product(s) to a cart; (6) selects discount & pay; (7) any other method of checkout. This means that the consumer could view the discount and the subsequent purchase price prior to selecting single action discount & pay as well as viewing it within the DDCPM.

In some embodiments, the DDCPM is able to communicate with the Open Banking Data modules to establish a credit line from one or more lenders. The DDCPM is then able to identify and/or issue a virtual PAN numbers that can be used to complete a transaction.

Once a discount code has been generated and applied, the system server 200 maps a client ID stored in the Client identifier module 216 to the client device and instructs the client device to inject the required payment, which is the updated discounted purchase price. In order to do this, the system server communicates the purchase price minus the discount (from the earlier discount code generation and application) with the DDCPM 101. The system server then instructs the DDCPM to inject the chosen payment data into the payment fields or sends tokenised payment data to processor. The system server may also have an intelligent payment assistant that enables the consumer to request banks and lenders to make bids for their purchase transactions in real time. The server generates the discount code and maps this to the Client ID. The DDCPM injects discount code into merchant app, website or point of sale system.

The system server 200 may send the discounted price to the DDCPM, whereby the DDCPM sends a message containing the purchase price and CPPS to a panel of banks and lenders. Banks and lenders map their bids to the unique Client ID and these bids are then communicated to the system server. The system server calculates the winning bid (eg. Based on duration, interest rates, reputation of the bank, and/or a user input), sends a message with the winning bid to the DDCPM and instructs the DDCPM to inject the payment data associated to the winning bid for the specific client ID into the merchants' app, website or point of sale system.

In some embodiments, the payment element of discount and pay can be configured to use pay by instalments, whereby a single action discount and pay by instalment plan is offered to consumers as an alternative to discount and pay, which takes the payment immediately rather than spreading the cost of the purchase over a specified period of time.

As used herein, single action refers to a situation where the consumer is already viewing a product and/or the product details page and then clicks or single tap/touch of a screen “Discount & Pay” once to obtain and apply their personalised discount/price, provide shipping and billing details, and make a payment, thereby completing a purchase with a personalised discount with one click of a mouse button, touch of a screen, voice command, keyboard stroke, biometric or any other method of applying a single action.

Moreover, the single action discount and pay can also be used within a basket or shopping cart, whereby the consumer can review their product(s) and select to purchase using discount and pay which applies the discount and takes the payment with one single click, touch of a screen, keyboard stroke, finger movement, biometrics or voice command or any other method that allows a consumer to make a selection. This avoids the current merchant checkout process of having to enter a discount code or click on a product to have the discount code populated at checkout and then select a payment method.

The single action discount and pay functionality can be broken down into three distinct processes: (1) enable single action discount and pay; (2) generate single action discount and pay; and (3) process single action discount and pay.

Firstly, to enable single action discount and pay, the consumer installs the Discount Code & Payment Manager application (DDCPM) on the client device 100 (e.g. on a mobile phone, tablet or computer). The consumer may then give permission to share their personal data including Open Banking data, purchase receipts and product searches such as on the system's product search engine or any other search function the consumer uses. The system server 200 then calculates the Consumer Purchasing Power Score (CPPS) based on this information and associates the CPPS with a Client ID. The merchant or supplier of products and services must then decide what level of discount to offer the consumer based on their CPPS. The discounts are added to a Merchant Value Scorecard (MVS), which is typically stored on the system server 200. The DDCPM uses the MVS to check the qualifying discounts for the client ID and generates codes (e.g. by transmitting a database lookup query to the system server to obtain the MVS and/or a modifier associated with a merchant.

With these methods, the consumer is able to view products and services on a merchants' app, website, in a physical store, or other medium and instead of going through the traditional “add to basket, review basket, checkout, insert promotional/discount code and choose payment method” process online or presenting a paper or digital voucher in a physical store at merchant's point of sale, and then making a payment, the consumer simply clicks one click single action discount and pay to obtain and apply a discount, make a payment, checkout and complete the purchase.

When the consumer is purchasing on-line at a merchants' app or website, the single action discount and pay functionality can be integrated into the merchants' website or app. In this use case, the consumer can view a product that a merchant has offered within their website or application and next to the product an icon/clickable button would present the eligible discount and the consumer would then click the button, touch a screen or voice command etc to perform a single action one click discount and pay.

When the consumer is purchasing in a merchants' physical store, the single action discount and pay is enabled when the consumer presents their products at point of sale for payment or exits the store with their products and the customer ID has already been established to connect the consumer and their chosen products. The merchants' point of sale system (e.g. the merchant server 300) may use a secure messaging system to connect with the DDCPM 101 and send a “Request for Discount and Payment” (RFDP). The client device 100 may then receive a notification to apply a discount and pay.

Once the single action discount and pay has been enabled as previously described, the system then generates the presentation of discount and pay. The single action discount and pay function can be presented on merchants' app or website when the consumer is purchasing on-line, and the discount and pay is rendered on a client device or can be presented on the DDCPM depending upon the configuration that is chosen. That is to say, the server can present the discount and pay function on a merchants app or website or the DDCPM itself can be used to present the discount and pay function.

The DDCPM shares the Client ID and Open Banking data for that client ID, purchase receipts and other relevant data including product searches and social media mentions with server. The server calculates the CPPS which is mapped to the client ID, and the server validates if the Client ID qualifies for a discount. If the Client ID qualifies for a discount, the discount is converted by the system into a unique discount code mapped to the Client ID. The server maps the stored payment method on the DDCPM or any live lender/bank bids to the Client ID. The server presents the single action discount and pay function (e.g. a discount and pay button) on the client device ready to be clicked on or voice commanded by the consumer.

The single action discount and pay is also transferrable to other mechanisms that essentially allow a discount to be given whilst simultaneously making payment. For example, other embodiments could use single action one click “Reward and Pay” or “Cashback and Pay”. Reward and Pay can be used where the consumer either has reward points that they wish to redeem as part of a purchase and/or where they select Reward and Pay to obtain rewards based on their CPPS as part of their purchase.

The discount/rewards can be presented to consumers using the consumer's client login details to assign the level of discount or rewards. The DDCPM logs in to the merchants' app or website and the Client ID is assigned discounts/rewards, these rewards are presented on the client device, whereby the consumer can view a product and their personalised discounts/rewards and then select “check out” to purchase the product without any requirement for a discount code and uses the consumer's stored payment card to make the payment. This enables the consumer to receive a discount without the need for a discount code as the purchase price has already been amended by the server using the client ID. The payment is then made using the consumer's stored payment card. Thus, the consumer can make a discounted purchase and a payment with a single action one click discount that uses the client ID to amend the purchase price and the stored payment card to make the required payment.

When the consumer performs the single action “checkout” by pressing an icon next to a product on a merchants' app and website, the client system 100 communicates this to the system server 200. The system server adds the product details to the unique client ID 102 and instructs the Pricing & Discount database 308 to provide the discount for a specific product or basket of products for that client ID. The system server presents the discounted prices for the qualifying products without any requirement for a discount code as the server has already rendered the personalised pricing based on the consumers' CPPS and then offers pricing based on the consumers' CPPS (as determined by the Client ID of the consumer). Once the pricing has been presented, and the consumer has selected their products, they can either add the products to their basket or checkout immediately, and both methods use the system server to take the required payment from the consumers' stored payment account that is mapped to their client ID. The discount is provided and the payment is taken all by using one single action check out, with the discount and the payment details then being transferred to the merchant server 300.

A consumer can use the system's product search engine for a volume discount and to search for single or multiple products within the system's own application. Once the consumer has entered (touched, typed, voice or photo) the search terms in the search bar, a choice of search types is provided, whereby (1) the consumer can either choose to search for the products, obtain the discounts and make payment with one single action one click ordering; (2) search the products and view the discounts available prior to making a payment; (3) search for the best rated products with the best discounts. In the scenario illustrated, the consumer has selected option 2 to search the products and view the discounts available prior to making a payment. The consumer then views the results of the products and associated discounts and can select which products to add to the system's universal shopping cart. The consumer can then checkout from the universal shopping cart using single action one click discount and pay.

In order for consumers to obtain a volume discount on single or multiple purchases using the discount and pay functionality, the consumer inputs product search term(s) 108 on client device 100 which communicates with server engine 203. Server matches consumers who have requested the same or similar products. Server's server engine connects with merchants' server 300 and extracts inventory databases 305 and produces product search results. Server extracts Merchant Value Scorecards from server 214 and defines discounts based on Consumers' Purchasing Power Score and volume of orders. Server presents products and discounts on client device browser 103 or mobile application 104. On client device, the consumer selects which offer is best for them (or can enable server to auto select best offer).

Server presents Shopping Cart 219 on client device with selected products. On client device, the consumer can select single action one click Discount & Pay in universal shopping cart. Server uses Discount Code Generator 212 to produce dynamic discount codes and stored in DDCPM On Client Device. DDCPM on client device communicates with server to assign product orders from various merchant apps or websites and matches discount codes to the correct merchants. DDCPM on client device injects dynamic discount codes and payment data simultaneously into discount code fields and payment fields on merchant apps and websites or sends tokenised payment data to processor to order products on behalf of consumer. Server communicates with client device and presents on client device confirmation of products orders, discounts and payment. DDCPM on client device communicates with server and updates Consumer Purchasing Power Score Database 211. Consumer Purchasing Power Score Database communicates with Dynamic Discount Code Generator 212 and updates Dynamic Discount Code Database 213. Dynamic Discount Code Database on server communicates with DDCPM on client device to store new dynamic discount codes ready to inject on merchants' app and website.

The single action discount and pay function can be combined with additional processes that enable the consumer to not only discover and search for products but also to provide the best rated products as voted on by consumers and that also have the most valuable discounts. This means that a consumer can enter a product they want either by touch of a screen, voice, keyboard/keypad entry or a photo/screenshot in the system's search engine, and with one click, touch of a screen or voice command, the consumer can select “Search, Rate, Discount & Pay”. The server then searches for the products in the same process as previously described but also communicates with the customer database and other external data sources to extract the NPS Scores that consumers have awarded particular products. The server then selects the top rated products with the optimum discounts and takes payment, whereby all of the activities described are actioned with one click, touch of a screen or voice command.

An additional function can also be added to promote the products to the consumers' network such as friends and family in return for a greater discount. Specifically, the consumer can use the “Search, Rate, Discount & Pay process but add a “promote” function that enables the consumer to promote the products they search for to their friends, family and/or network of contacts. The system follows the same process for Search, Rate, Discount & Pay but sends the product results of the search to the consumers' chosen contacts. This means that if the recipients decide to also purchase the product, a greater discount may be offered for bulk purchases. The system searches for the products, presents the ones with the best NPS Scores, sends those product descriptions to the selected contacts, where the recipients can decide to purchase the product and obtain a bulk discount and payment is then taken. The system is not limited to just the single action option described in those particular sequences, but rather it can be a combination of some or all of the single action purchase options. Moreover, the single actions described can be a touch of a screen, mouse button click, a finger movement, voice command, biometrics or any other method which can allow the consumer to make a selection.

Single action discount and pay can also be used to help consumers time their purchases for the best discount by integrating a time element within the discount and pay function, creating a single action touch of a screen, mouse click, finger point, keyboard stroke or voice command “Time Discount & Pay” function. This would enable consumers to understand when other consumers purchase the same or similar products as themselves by assessing the Consumer Purchasing Power Score, Open Banking data and product receipts along with product searches on the system's product search engine. The consumer can then form a buying group to purchase at the time that the majority of consumer purchase the chosen product(s). This means that by timing the purchase of the consumers' chosen product(s) a volume discount can be obtained based on placing bulk orders at the optimum time.

So, if for example, a consumer wanted a deodorant, they could find out what brand the majority of people are purchasing, the day and time that the majority of consumers purchase the deodorant and can set up a timed purchase to place their deodorant order with the majority of consumers. The system effectively acts as a broker to pool the orders of consumers at the optimum buying time for a bulk discount.

When the consumer decides to select Time, Discount & Pay for their purchases, the server maps their client ID 102 to the product details that have been selected and the server assesses the requested products against previous purchases made by consumers and current product requests and calculates the optimum time when the majority of consumers purchase. The server provides the client device 100 with a message displaying a recommendation of the most popular time to purchase and sends the same message to all other client devices that have purchased the same or similar products. The system then acts as a broker and places a bulk order for all consumers to gain a volume discount.

A further element that can be added to the single action discount and pay is to enable consumers to understand the environmental impact of their purchases creating a single action “Impact, Discount & Pay”. The consumer would be able to select purchases that have the lowest environmental impact, obtain a discount on those purchases and make payment in one single action touch of a screen, mouse click, finger point, keyboard stroke or voice command. The environmental impact score would be comprised of a number of factors that impact the environment with each product being given a score. That score would then be combined with the discount and pay function to enable the consumer to make purchases with their discount that have the best or lowest impact to the environment.

Single action discount and pay can also be integrated with personalisation of products. So for example, if a consumer is purchasing a pair of trousers, the consumers' preference for shape, size, colour, material etc can be stored in the DDCPM 101. When the consumer views a product they like on a merchants' app or website, in this case, a pair of trousers, the consumer can select to purchase using single action “Personalise, Discount & Pay” for immediate selection of the preferred style of trousers, the correct size, colour, material etc without the consumer having to manually select those preferences. The DDCPM can then interact with the merchants' website to select an appropriate product (e.g. the user may browse to a webpage for a good, select “Personalise, Discount & Pay”, and then an appropriate size, colour etc. of the good is selected and paid for by the DDCPM).

Simply put, the consumer can purchase a product that requires personalisation such as clothing, footwear, jewellery, food, make up etc without having to select or enter any personalisation fields and options, obtain a discount and make a payment and then checkout with one signal action touch of a screen, click of a mouse button, voice command, keyboard stroke, finger selection, biometrics etc.

An affordability check on individual products can be used with single action discount and pay is to help consumers understand the affordability of their intended purchase(s) and/or basket of purchases by creating a single action “Affordability, Discount & Pay” to check whether the consumer can afford the product in any given specified period of time such as one month and then follow the discount and pay process previously described. The system uses the consumers' Open Banking data to provide an assessment of whether the consumer can afford the purchase and presents an indicator of “yes, affordable”; “no, not affordable at this time, wait x number of months”; or yes, affordable with instalment plan or credit payment”. Moreover, if the product or basket of products are unaffordable, the system can present options to the consumer to help them afford the product, such as using a credit facility, which could be an instalment plan or credit card.

In some embodiments, the consumer is able to promote their intended purchases to their friends and contacts for a bulk discount, whereby the reduced bulk purchase price could positively impact the affordability rating. Other options can include providing cashback if the consumer switches their telco, financial services, energy provider or any other service provider they currently use, whereby the cashback could be deducted from the cost of their intended purchases. Depending on the level of cashback received, the consumers' affordability for their basket could be positively impacted, i.e. turning an unaffordable shopping cart to an affordable cart.

In order to access the affordability rating, the consumer would go through the process described to obtain their Consumer Purchasing Power Score mapped to their client ID. The server would then calculate the consumers' available income after expenditure from Open Banking data 207 mapped to unique client ID 102 and set the financial parameters in the server for that client ID. The server would then illustrate the affordability options on client device 100 for some or all products that the consumer views on a merchants' app or website. The consumer can then make an informed judgement as to when and how to make the purchase. So for example, if a consumer had £500 available income for a month, the server would instruct the client device to display “yes, affordable” for products with a cost below £500.

If the consumer uses one click discount and pay for immediate discount, payment and checkout for a specific product or several products, the cost and payment of the product(s) would be factored in to the affordability ratings for any future purchases. Where the consumer decides to add products to a shopping cart, the server instructs the client device to display individual affordability ratings for each product and for the total basket. It can be configured with various product and affordability hierarchies to determine affordability on a per product basis. Moreover, if the affordability system is configured within a universal shopping cart, it can provide a full affordability assessment of all of the consumers' intended purchases rather than from one individual merchant. The result of the single action Affordability, Discount & Pay function is that with one click the consumer can purchase all products they have selected that have been determined as affordable and with a qualifying discount. The system can of course also be configured to operate independently of single action discount and pay, whereby the affordability assessment is presented as part of a shopping cart or other location on a merchants' app or website.

The system can be used to provide personalised pricing and presented to the consumer for any merchants' app or website visited. Server extracts Merchant Value Scorecards 214 from server and defines discounts based on Consumers' Purchasing Power Score 211 and Merchant Value Scorecard 218 and maps these to unique client ID. DDCPM 101 on client device communicates with server to alert the system to active merchants' apps and websites. Server matches discounts to the correct active merchants and communicates these discounts to client device's DDCPM. DDCPM on client device converts the discounts to prices that are then rendered and presented as web pages or screens that interface with merchants' own apps and websites.

Depending on the configuration with the merchant, the server can also communicate with merchant's server Inventory Database 305 and Pricing Database 308 to instruct pricing to be decreased/increased for unique client ID according to the specified values within the Merchant Value Scorecard. Server communicates pricing for unique client ID with DDCPM on client device and injects new pricing for some or all listed products on merchant apps and websites for a specific client ID. The consumer can then view the discounts with reduced/increased pricing that is specific to their client ID and presented on client device using the DDCPM. The system can be used to provide personalised pricing for specific products, a basket of products or all products.

A discount code, device ID, client ID or any other identifier can be used by the system to instruct a merchants' server to amend a price, the outcome for the customer remains the same in that they can purchase a product with a discount by using a single action one click that enables them to obtain a discount or personalised price and make a payment. Where an identifier is used to attribute discounts or personalised pricing to a consumer, the consumer installs the system's mobile application (the DDCPM) and the application instructs the server on the specific discount or pricing that client ID is eligible for. This means that the consumer does not have to log in to individual merchants to access their discounts or personalised pricing as the DDCPM interfaces directly with the merchant.

The system can also be configured to inject discount codes or use the client ID to apply a discount or personalised price as soon as a consumer opens a merchants' app or visits a merchants' website. The consumer can view a product and either add it to a shopping cart with the discount already applied or use the system's immediate one click checkout. The system then sends the payment having already provided the discount code or applied a discount via the client ID as soon as the consumer opened the merchants' app or website, thereby enabling a discount and payment to be obtained with one click of a mouse button, touch of a screen or voice command etc.

In addition to the advance application of a discount code or personalised price described above, the system can enable a discount code to be injected as soon as a consumer has clicked on or hovered over a product to view it in more detail. The action of clicking on a product that a consumer is viewing on a website or app automatically checks for any qualifying discounts and then injects them into the shopping cart. Again, the system can either use a discount code or client ID to apply the discount or personalised price. The consumer can again use the system's one click checkout for immediate purchase with the discount applied or add to a shopping cart and then checkout.

A further method enables the consumer to add a product to a shopping cart, where the action of adding the product to a shopping cart automatically injects any relevant qualifying discount code or uses the client ID to provide a personalised price. The consumer can then checkout from the cart with one click payment having already had the discount or personalised price applied.

The disclosure also enables a retrospective discount to be offered to a consumer that has already made a purchase. Server communicates with client device and presents offers for purchases made in the last, e.g. 14, days that consumer could switch to. Consumer can select “Retrospective Discount” next to the purchase transaction to obtain a discount. Server communicates with merchants' server 300 and sends price match or refund notification to customer services 309 and original supplying merchant can either accept price match and credit the difference or refund item when returned. If original supplying merchant does not price match, the server issues a product return and refund notification to merchants' server. Once product return and refund is confirmed, server orders the product with new supplying merchant. DDCPM on client device injects dynamic discount codes and payment data simultaneously into discount code fields and payment fields on merchant apps and websites. Server communicates with client device and presents on DDCPM on client device confirmation of discount and payment.

The system enables consumers to obtain a discount and make payment with single action one click discount and pay when in physical merchant stores. The consumer follows the previous processes described to obtain their Consumer Purchasing Power Score and downloads Dynamic Discount Code & Payment Manager Application (DDCPM) on client device, which enables the consumer to access their eligible discounts from merchants and other providers. DDCPM on client device uses location identifiers to determine if consumer is in a physical merchant and matches discount codes to the correct merchants.

The consumer takes their products to a physical checkout and the merchant's Point of Sale (POS) system identifies Client ID 102 and sends a “Request for Discount Validation & Payment” (RFDP) 109 to the client device (mobile device) 100. The RFDP is a secure web and mobile app messaging application that communicates a required payment and requests any eligible discounts from the client device's DDCPM. The consumer receives the notification on client device and selects “Discount & Pay” next to the notification. The client device using its unique client ID 102 sends a request to the server to validate the eligible discount for the specific merchant using the Merchant Value Scorecard (MVS) 214. The server sends the DDCPM 101 the discount code. The discount code and payment is then sent by the DDCPM on client device to the merchant POS system where the discount code is validated and applied along with the payment using single action one click discount and pay. The RFDP ensures that the consumer receives their discount and makes payment with a single action discount and pay. This ensures the consumer has a consistent shopping experience for their on-line purchases as well as their in-store purchases, whereby the consumer can make online and in-store purchases using single action discount and pay.

An alternative method for using discount and pay in store is to use QR codes or barcodes. The consumer is able to present to the cashier or at self service a QR code that contains the unique discount and the payment method and this enables the fastest option to obtain a discount and make payment simultaneously without a separate presentation of either a paper voucher or digital voucher. Consumer follows the previous processes described to obtain their Consumer Purchasing Power Score and downloads Dynamic Discount Code & Payment Manager Application (DDCPM) on client device.

DDCPM 101 on client device uses location identifiers to determine if consumer is in a physical merchant and matches discount codes to the correct merchants. The discount codes are converted into QR codes by the QR Code Generator 220 on the server. The DDCPM on client device presents discount and payment data embedded in a QR code. Consumer presents QR code to cashier or self serve where the discount and payment is applied. The same process can be used with a variety of applications that include Near Field Communication (NFC) and bar codes and is not limited to just QR codes but rather can incorporated with whatever applications particular merchants want to use.

The system enables consumers or businesses to purchase gift discount codes (gift vouchers) for other consumers. The consumer or business uses the Discount Code & Payment Manager to enter the amount they wish to send and the contact details of the recipient(s). The consumer or business can then manually select a merchant for the recipient to spend at or they can use the system to offer the most suitable merchants based on the recipient's Consumer Purchasing Power Score.

The recipient receives an SMS or other notification to inform them that they have received a gift voucher. The recipient downloads the Dynamic Discount Code & Payment Manager (DDCPM). The server assigns a client ID to the recipient and matches this with the client ID of the sender to obtain the value of the gift voucher and the designated merchant where the gift voucher can be spent if the sender has selected one. The recipient selects on the DDCPM whether they wish to use the gift voucher on-line or in a physical store. The gift voucher monetary amount is converted into a discount code 212 for on-line spend or in store spend.

The recipient can also select to use their Consumer Purchasing Power Score to view offers from different merchants who may increase the value of the original gift amount. Merchants can use the CPPS to identify high value consumers and increase the gift amount as a way of acquiring new customers and/or encouraging deeper loyalty with existing customers. To do this, the client device 100, and the DDCPM 101, may be arranged to receive offers from the system server 200 and/or the merchant server 300 (e.g. via the system server). The recipient can view the different merchant offers and click on those merchants offers to visit the merchants' app or website, select a product(s) and choose Discount & Pay to apply the gift voucher which will be in the form of a discount code that is injected into the discount code field and the payment data is entered into the payment field or tokenised payment data sent to processor (payment will be required if the consumer has spent more than the gift voucher or merchant offer).

The system server 200 may be arranged to receive transaction requests from a plurality of client devices and to associate these requests based on a similarity between the requests. The modifier and/or the discount may be dependent on the plurality of transaction requests. In this way, the system enables consumers to interact with their friends to discuss a product or group of products whilst on a merchants' app or website. The intended purchaser can also influence their friends to purchase the same product for a greater discount than what they would obtain individually using their Consumer Purchasing Power Score. This embodiment enables consumers to interact with each other using an integrated messaging and screen sharing system to discuss a product(s) and/or brand and “match” with each other and to organise themselves into a buying group for a bulk purchase. The consumer follows the previously described process for obtaining their Consumer Purchasing Power Score. The consumer visits a merchants' app or website and selects the icon “Connect with Friends” which then enables the consumer to selects friends from their contacts, whereby the group of friends receive a notification to open the merchants' app or visit the merchants' website and can view the same product that the initiating friend is viewing.

Once the “Connect with Friends” icon is clicked on, touched on a screen or voice commanded by the consumer on the client device 100, the client device communicates with the system's server 200 and sends the consumer's contacts data to the customer database 205. The server is instructed to use the contact data to send a notification (eg. Via SMS) to the client's device selected contacts. The recipients open the SMS and download the Dynamic Discount Code & Payment Manager (DDCPM) 101 if they don't already have it. The DDCPM then acts as the interface between the merchant's server other client devices to present the product(s) that the initiating consumer who selected “Connect with Friends” is viewing.

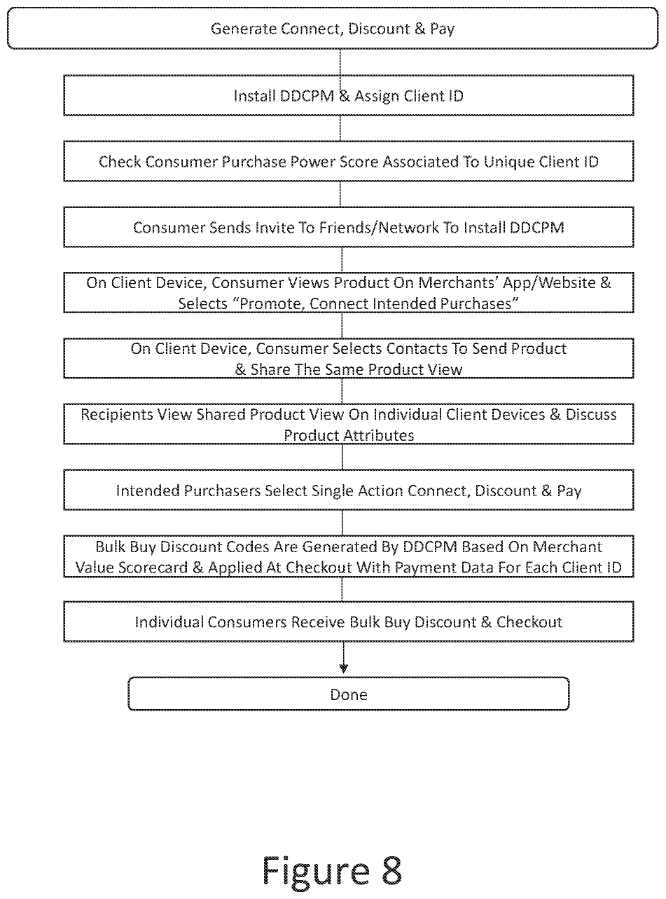

The DDCPM on client device communicates with the server to exchange data flows such as product views, product description and product pricing. The DDCPM enables video and instant messaging between the selected friends/contacts of the consumer. The friends can then discuss this product and can decide to purchase the product as a buying group for a bulk discount. If particular friends decide they wish to purchase the same product, they can connect their purchases by each selecting “Connect, Discount & Pay” on the client device, via mobile application 104 or web pages on browser 103 which identifies the friends as a buying group. The server adds the product details and the unique client ID 102 of each friend/contact and assigns the eligible discount level from the Merchant Value Scorecard 214 on server (e.g. as shown in FIG. 8).

The system can also use the consumers' separate Consumer Purchasing Power Scores to provide individual levels of qualifying discounts or the merchant may simply decide to offer one rate of discount for bulk purchases. In either case, the single action ordering using “Connect, Discount & Pay” connects the friend's/contacts intended purchases, applies the qualifying discount and makes payment using the optimum payment method (credit, debit, or instalment and most advantageous lender for that specific consumer) simultaneously.

The DDCPM is typically arranged so that the discount and pay functionalities can be used with and within a universal shopping cart, whereby the consumer can add their products to the universal cart from different merchants. This enables the consumer to review any or all of their products from the merchants they shop at before they commit to making payment. Instead of using the discount and pay function next to the product they are viewing for immediate discount, payment and checkout, they may decide to add products to the system's universal cart to review in full all of their intended purchases and to understand the affordability and the options available to them to ensure their purchases are affordable. Moreover, the consumer can promote their intended purchases to the network of contacts for a bulk discount and/or ask their advice about the product(s). The functionality is contained within the system's one single universal shopping cart. The discount and pay functionality can be integrated within the universal shopping cart to enable consumers to checkout with single action discount and pay once they have reviewed and decided on their intended purchases. The system's universal shopping cart is able to receive and accept an unlimited number of discount codes which enables merchants to provide personalised pricing on individual products, a category of products, a basket of products or particular brands. The discount code may not actually be seen by the consumer but used by the system to track performance and action and apply the personalised price, which could be in the form of a discount or even an increase in the standard pricing depending on the consumers' purchase power score.

A consumer can select products from different merchants and add those products to the system's universal shopping cart. The shopping cart can then use the consumers' CPPS and Open Banking data to provide an affordability assessment on the individual product cost and the total basket cost, with a recommendation as to how the consumer should proceed with the purchase (affordable/not affordable at this point in time) and the payment options for the purchase. Where the product or basket of products is unaffordable, the consumer is presented with a number of options to potentially enable the purchase to become affordable, such as using an instalment plan, switching services such as telco, energy, insurance and/or promoting the products to the consumers' friends and network of contacts for a bulk purchase discount. The result of the consumer acting on the recommendations may mean that their basket has become affordable.

The present disclosure can be used in a number of other environments; for example, the present disclosure can be used within a banking and personal financial management application. The consumer is presented with a view of their recent transactions, whereby the consumer can view their retail purchases and click on the merchants where they have made their previous purchases. Once the merchant icon has been clicked, this takes the consumer to a view of discounts based on their Consumer Purchasing Power Score. Other merchants that the consumer has not purchased from can also appear on the presentation of discounts. The discounts can be either for a basket of products or a specific products or a combination of both. If the consumers wishes to make the purchase, they can do so using single action one click discount and pay. The Dynamic Discount Code & Payment Manager then confirms the order and the payment is taken.

The present disclosure can be used within a merchants' website or application whereby the consumer can view a product and view their eligible discount that is based on their CPPS whilst also making a payment without the consumer having to view or enter discount codes or payment information. In this use case, the consumer can view a product that a merchant has offered within their website or application and next to the product an icon would present the eligible discount and the consumer could then select the icon to perform a single action one click discount and pay. Depending on how the merchant wishes to configure the system, the discount can either be shown as a separate presentation or can actually feature within a single icon that the consumer can view without having to click to view the discount. The one icon can also enable the single action discount and pay when clicked on.

Detailed implementations of various methods of the invention are described below. It will be appreciated that aspects of each implementation may be used in any combination.

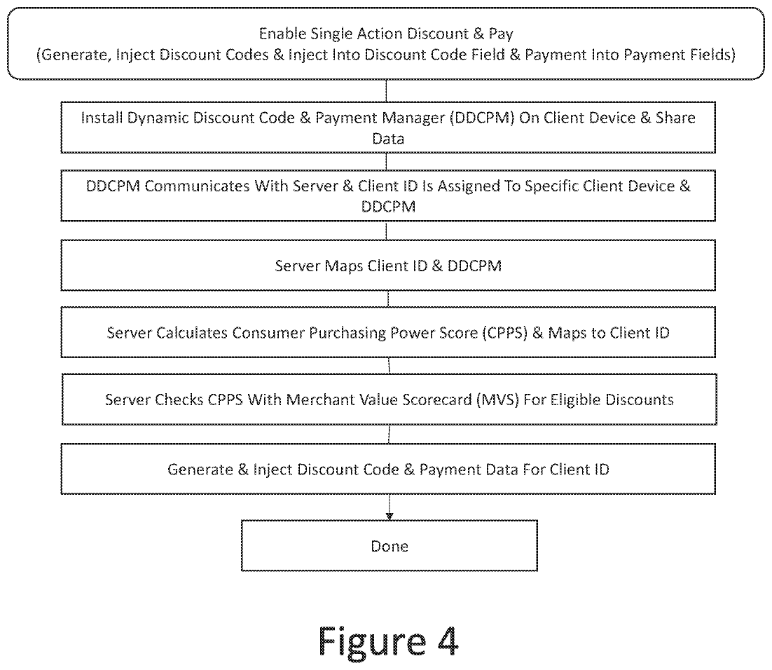

Referring to FIG. 4, there is described a method of transmitting a discount code associated with a user.

In a first step, a user enables single action discount and pay (e.g. by installing the DDCPM in a second step). In a third step, the DDCPM communicates with the system server 200 and is assigned a client ID. In a fourth step, the system server maps the client ID to the DDCPM and the user and stores this client ID. In s fifth step, the system server calculates a score for the user and associates this score with the client ID. In a fifth step, the system server compares this score with a merchant value scorecard to identify eligible discounts for the user and to determine a modifier associated with the user and with a good or service. In a sixth step, the system server transmits to the merchant server 300 a transaction request that comprises the modifier and, optionally, payment details.

In some embodiments, the user is shown one or more possible discounts. Equally, these discounts may be applied automatically.

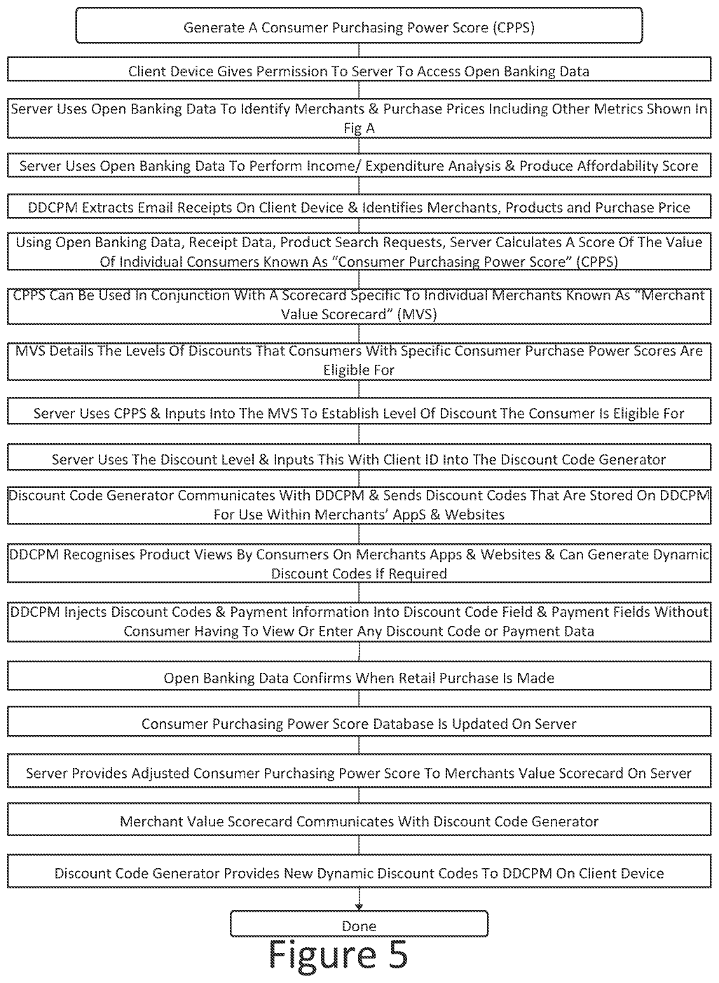

Referring to FIG. 5, there is described a detailed method of generating dynamic discount codes. In a first step, the client device 100 gives permission to the system server 200 to access user information (e.g. open banking data). In a second step, the system server 200 uses this information to identify relevant merchants and/or products. In a third step, the system server uses the information to determine an affordability score of the relevant merchants and/or products. In a fourth step, the DDCMP 101 on the client device 100 extracts information associated with the user and, in a fifth step, the DDCMP uses this information to determine a score for the customer. In a sixth step, a merchant value scorecard is associated with the score, and in a seventh and eight step, the system server uses the score to determine a modifier associated with the user and with a good and/or service. In a ninth and tenth step, the system server uses the score to generate discounts for the user (e.g. by determining discounts that are eligible for use with a merchant). In an eleventh and twelfth step, the system server uses the discounts to complete a purchase. In a thirteenth step, the system server confirms the purchase and then, in a fourteenth step, the system server updates the score for the user. This process is repeated to enable the system server to provide up-to-date scores and modifiers for the user as the user continues to purchase products.

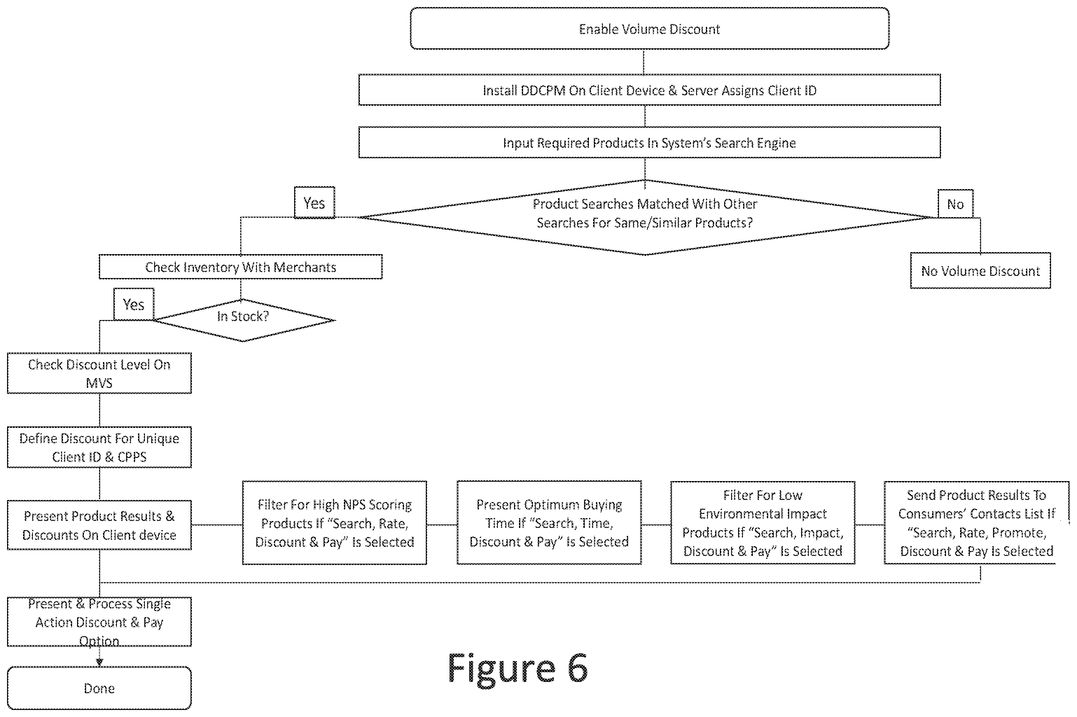

Referring to FIG. 6, there is described a method of generating a discount for a volume purchase. In a first step, the system server 200 assigns a DDCPM to the client device 100. In a second step, the system server receives an indication of required products from the client device. In a third step, the system server identifies associated indications from other client devices. In a fourth step, the system sever identifies a merchant that stocks relevant items and in a fifth step, the system server determines a modifier for these items, where the discount depends on the scores of the users that have provided the indications. In a sixth step, the system server presents the modifier to the user and in a seventh step the system server transmits an acceptance of the modifier to the merchant server 300 to complete the transaction. The completion of the transaction may depend on a user selection, e.g. the user may select an offer in dependence on environmental concerns, shipping time, discount amounts etc.

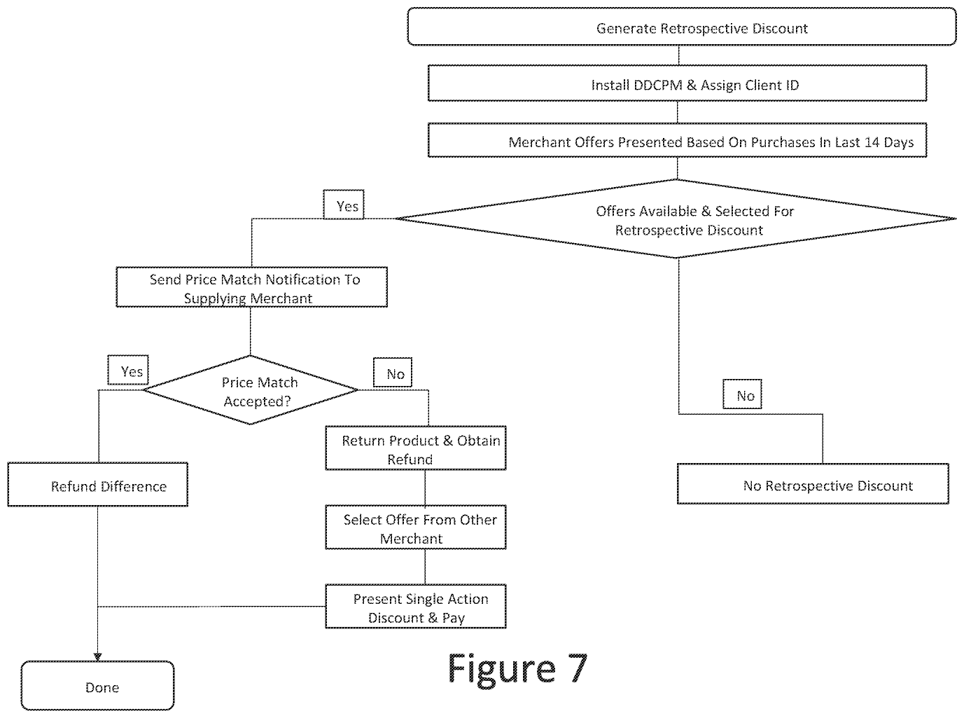

Referring to FIG. 7, there is described a method of generating a retrospective discount. In a first step, the user installs the DDCPM and the system server assigns a client ID to the user and the DDCPM. In a second step, the system server identifies merchant offers based on the prior activity of the user (e.g. based on purchases made by the user in the past 14 days), in a third step, the system server determines whether retrospective offers are available, in a fourth step, the system server sends a notification to the merchant server 300. In a fifth step, the system server determines whether the retrospective discount has been accepted by the merchant. If the retrospective discount has not been accepted, then the merchant server may organise a return of the product and may determine a merchant (and a merchant server) that is willing to provide a discount. The system server may be arranged to submit a transaction relating to the product in question to this willing merchant server so as to purchase the good.

Referring to FIG. 8, there is shown a method of an individual consumer obtaining bulk buy discounts. In a first step, a user installs the DDCPM and the system server assigns a client ID to this user and DDCPM. In a second step, the system server determines a score for the user. In a third step, the user invites their friends to install a DDCPM. Each of the user and the friends then views a similar product, and the system server receives transmissions from the client device of each of the user and the friends and identifies that these parties are viewing a similar product. Thereafter, the system server determines a modifier (e.g. a bulk discount) based on the plurality of view and/or on the scores of each of the parties.

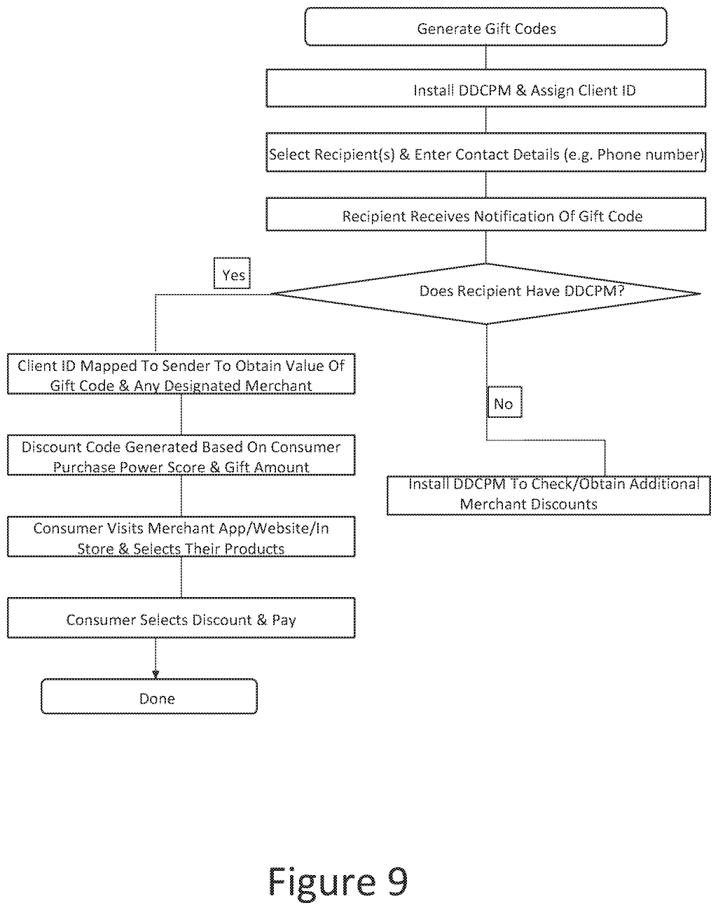

Referring to FIG. 9, there is shown a method of providing a gift code to a user. In a first step, a user installs the DDCPM and the system server assigns a client ID to this user and DDCPM. In a second step, the recipient of the gift card is selected by the user. In a third step, the system server transmits a gift code to the recipient. In a fourth step, the system server identifies whether the recipient already has a DDCPM installed, if not then the system server may direct the recipient to a store for downloading a DDCPM. In a fifth step, the system server determines a value of the gift code and in a sixth step the system server generates a discount code in dependence on this value and on a score of the user and/or the recipient. This discount can then be used as part of the purchase of a good.

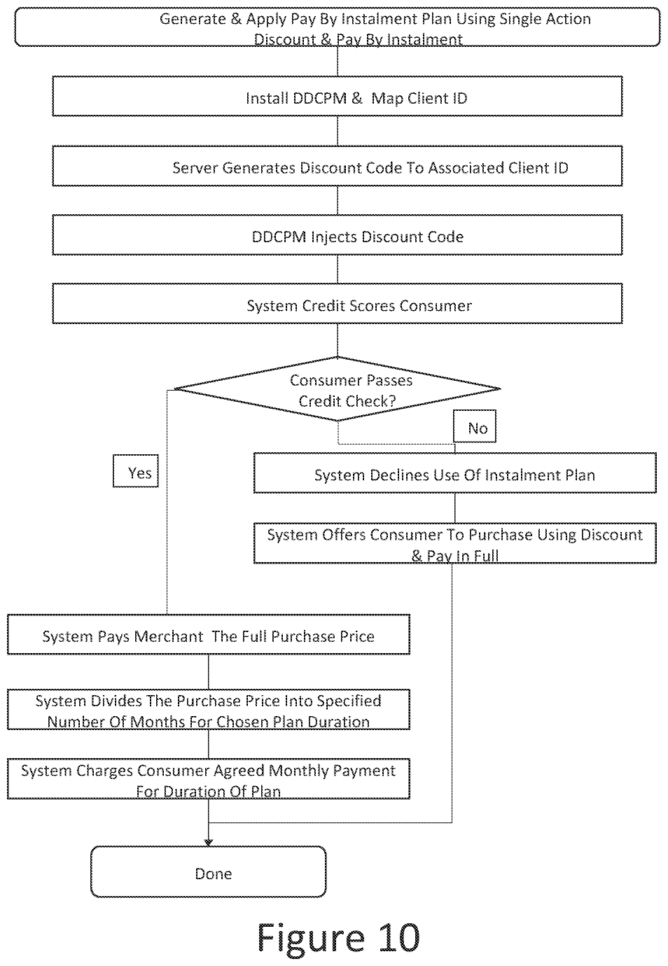

Referring to FIG. 10, there is shown a method of agreeing a monthly payment plan with a user. In a first step, a user installs the DDCPM and the system server assigns a client ID to this user and DDCPM. In a second step, the system server generates a modifier for the user (based on the user's score). In a third step, the system server determines a credit score for the user. In a fourth step, the system server determines whether the user qualifies for an instalment plan. In a fifth step, if the user qualifies for an instalment plan, the system server offers an instalment plan to the user. If the instalment plan is accepted, then the system server transmits a payment request to the merchant server with the payment request paying the full price of the product. The system server then regularly transmits payment requests to the client device in accordance with the instalment plan.

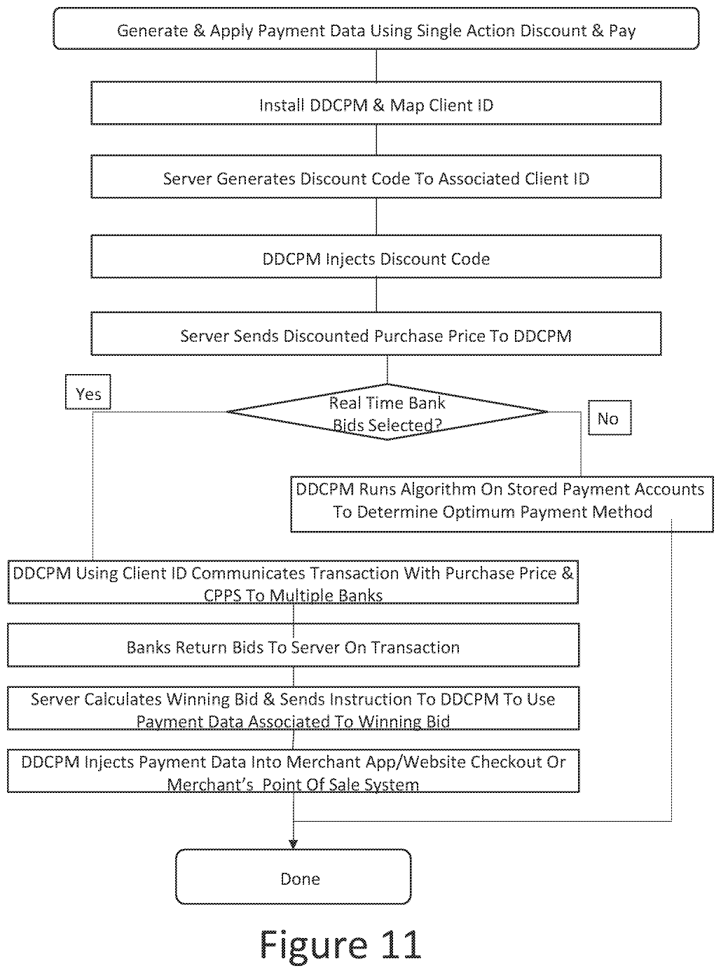

Referring to FIG. 11, there is shown a method of agreeing a bid on a transaction with a user. In a first step, a user installs the DDCPM and the system server assigns a client ID to this user and DDCPM. In a second step, the system server generates a modifier for the user (based on the user's score). In a third step, the system server receives one or more bids from third parties associated with the user and the modifier. In a fourth step, the system server determines a winning bid (e.g. based on a user input) and in a fifth step, the system server transmits a transaction request to the merchant server based on the winning bid.

More generally, an offer transmission (e.g. a payment request) generated in dependence on the score and/or the modifier may be transmitted to one or more third party devices. The third party devices may then transmit to the system server 200 and/or the merchant server 300 a bid transmission that relates to the offer transmission. The offer transmission may be processed by the system server and/or the merchant server in dependence on the offer transmission. In particular, the system server and/or the merchant server may be arranged to accept one bid transmission from a plurality of bid transmissions and to proves the offer transmission in dependence on the accepted bid transmission. This may comprise determining payment details for the offer transmission in dependence on the accepted bid transmission, where the offer transmission may relate to a payment request from a user and the bid transmissions may relate to bids from financial institutions to provide credit for the payment.

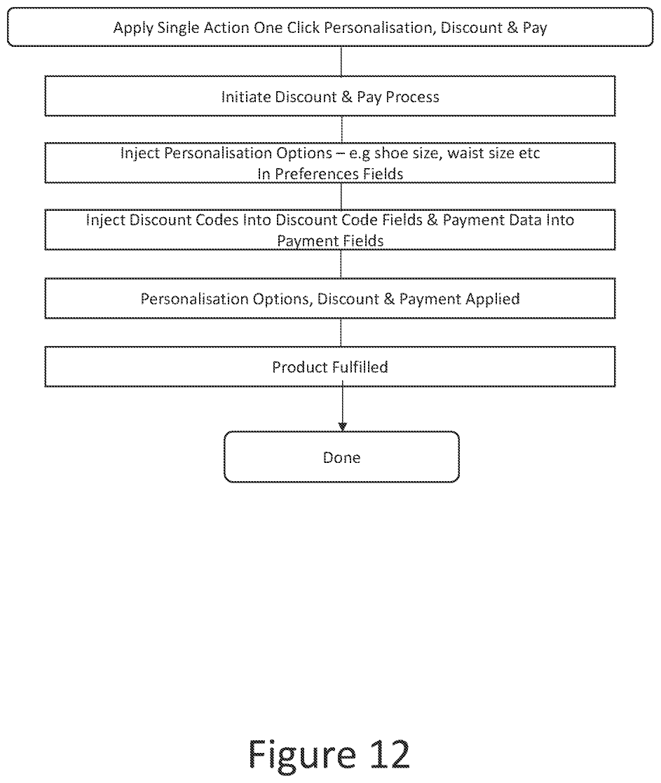

Referring to FIG. 12, there is shown a method of transmitting a transaction comprising personalisation information. In a first step, a user installs the DDCPM and the system server assigns a client ID to this user and DDCPM. In a second step, the system server determines personalisation information associated with the user. In a third step, generates a modifier for the user (based on the user's score). In a fourth step, the system server transmits a transaction request to the merchant server based on the personalisation information and the modifier.

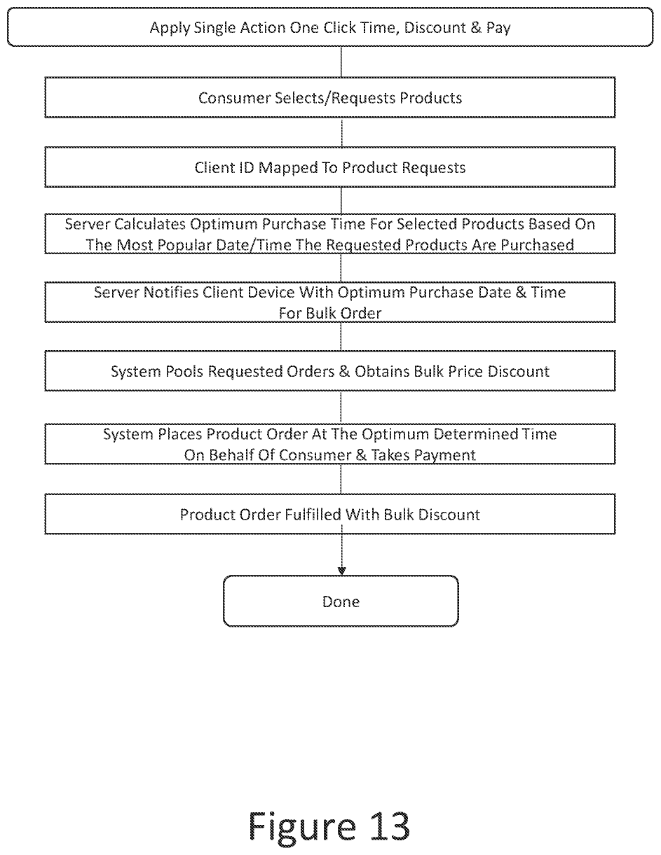

Referring to FIG. 13, there is shown a method of buffering transaction requests to obtain a bulk discount. In a first step, a user selects desired products. In a second step, the system server calculates an optimum time for purchasing these products (e.g. a time at which these products are at a minimum price). In a third step, the system server indicates this time to the client device. In a fourth step, the system server identifies other requests for similar products. In a fifth step, the system server pools the requests and transmits a bulk order to the merchant server 300 based on the requests.

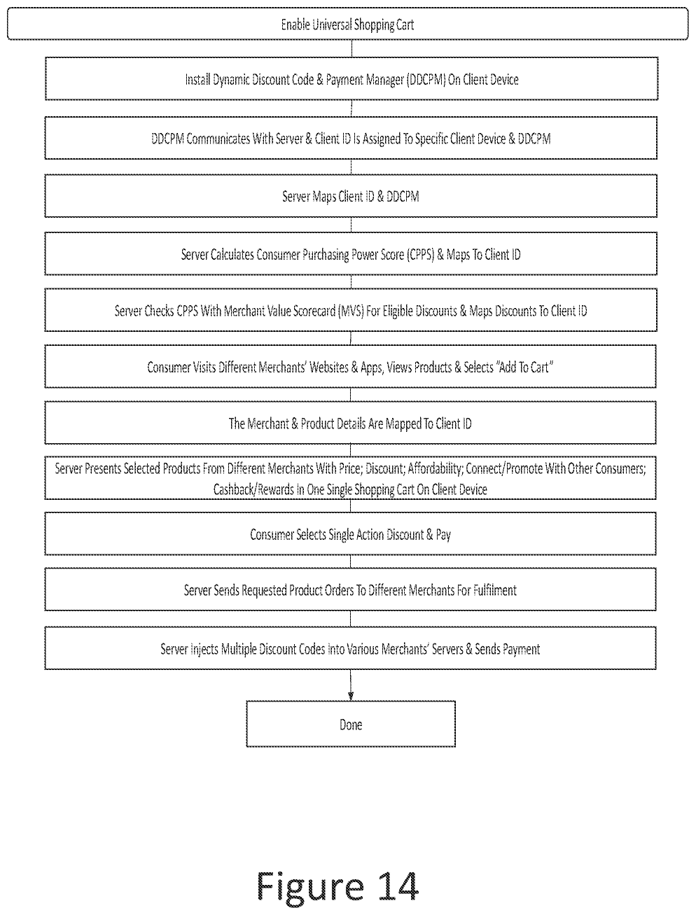

Referring to FIG. 14, there is described a method of completing transactions associated with a plurality of merchants. In a first step, a user enables single action discount and pay (e.g. by installing the DDCPM in a second step). In a third step, the DDCPM communicates with the system server 200 and is assigned a client ID. In a fourth step, the system server maps the client ID to the DDCPM and the user and stores this client ID. In s fifth step, the system server calculates a score for the user and associates this score with the client ID. In a fifth step, the system server compares this score with a merchant value scorecard to identify eligible discounts for the user and to determine one or more modifiers associated with the user and with a good or service. In a sixth step, the user visits a plurality of merchant sites and selects a plurality of products. In a seventh step, the system server associates each of these products with the user and with a respective modifier. In an eighth step, the system server transmits transaction requests to each of the plurality of merchants, with each transaction request comprising one or more modifiers.

Referring to FIG. 15, there is shown a system architecture for the generation of consumer and business scores that may then be injected into payment schemas, where the payment schemas (payment messages) can be sent to Financial Institutions and other participating organisations for bidding on individual payment transactions, financial transactions, foreign currency payments and bank transfers.

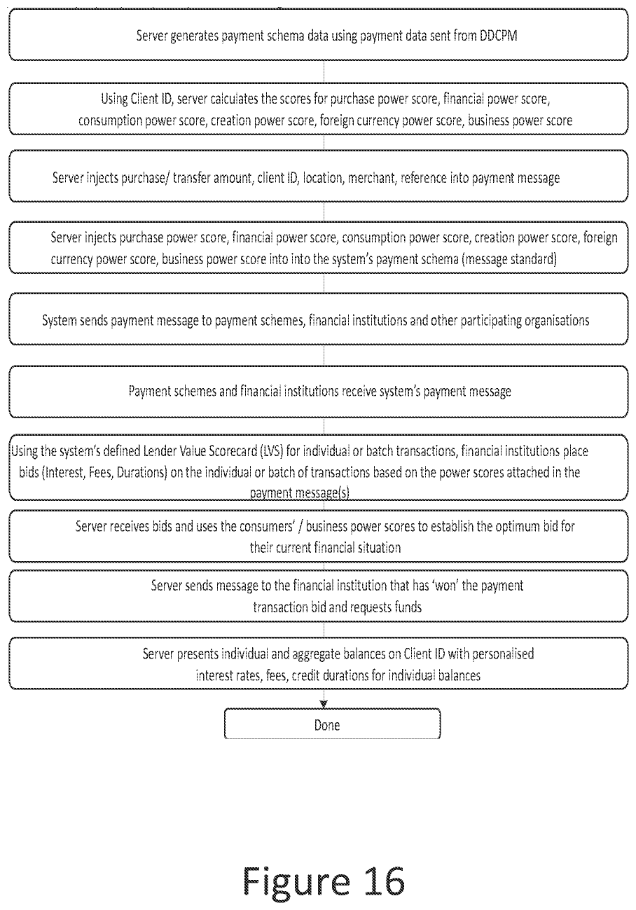

Referring to FIG. 16, there is shown a process for generating and inserting the consumer or business scores into a payment message for the application's payment system or any other payment system and sending and receiving payment bid requests using the previously described power scores within a payment schema or any other message standard. The system can be used pre (real time bids) or post (retrospective) transactions being made.

In a first step, the system server 200 generates payment schema data using payment data received from the DDCPM 101. In a second step, the system server calculates scores for the user. In a third step, the system server injects a purchase amount and transaction context parameters into a payment message along with the scores. In a fourth step, the system server sends the payment message to a plurality of financial institutions. The system server receives bids from each of these institutions and selects a winning bid based on a user input and/or user information. This winning bid is accepted (and this acceptance is transmitted to the user and to the winning institution).

The system server may use the Auction Manager 1022 to set a pre-determined time period to receive bids from Financial Institutions and other participating organisations and may then sends received bids to participating organisations using the Payment Bid Request Receiver 1025 to obtain counter bids. The system server using the Payment Bid Manager 1019 then receives the final bids once a selected auction time period has ended and uses the power scores to establish the optimum bid for their current financial situation.

The Payment Schema Generator module 1020 generates the payment schema. Using the Client ID 1003, the system server 200 calculates the scores for: purchase power score, financial power score, consumption power score, creation power score, foreign currency power score, business power score. The system server 200 then injects the payment data sent from the DDCPM into the payment schema. The system server, using the Payment Scheme Communicator module 1021 sends the payment message or schema to participating Financial Institutions and other participating organisations. The Financial Institutions' Server 400 receives the system's payment schema or message standard using the Payment Bid Request Receiver module 1025.

Using the Lender Value Scorecard 1027, the financial institutions server 400 generates an offer using the power scores 1016 for the individual payment transaction, bank transfer or batch of payments or financial transactions, which is generated by the Payment Offer Generator 1026. The Payment Bid Manager 1019 receives the bids from the Financial Institutions and other participating organisations and the Payment Bid Calculator 1018 calculates the optimum bid for the consumer or business using the power scores 1016 and Open Banking/Open Finance Database 1012. The Payment Bid Manager 1019 communicates with the Payment Communicator 1028 to provide an approved or declined message for a specific individual or batch of payment transactions, financial transaction, foreign currency payments or bank transfers.

The Payment Schema Communicator 1021 requests the funds or balance from the Balance/Payment Transfer 1029. The system server 200, using the Mobile Applications Screens 1010 and Web Pages 1011, sends and presents the individual balances and aggregate balances with the Client ID 1013 to the DDCPM 1001 and the balances with the personalised interest rates, fees and durations and any promotional offers are presented on the Client Browser 1004 or Mobile Application 1005 or any other Client device.

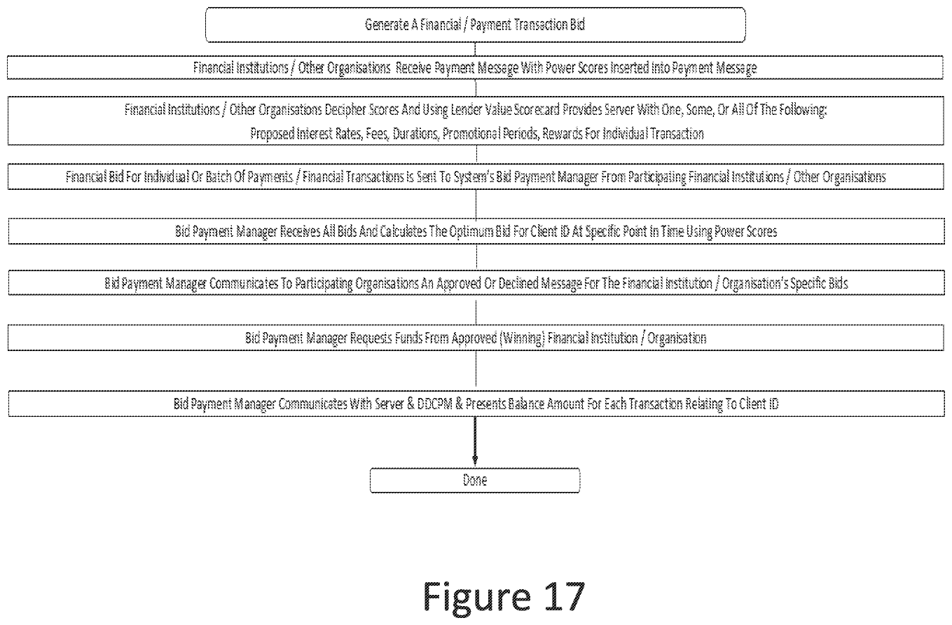

Referring to FIG. 17, there is shown a process for generating, receiving and presenting an individual payment or financial transaction or batch of payment or financial transactions. Financial Institutions and other participating organisations receive the system's payment schema or payment message with power scores injected into the payment message. In a first step, the financial institution server 400 receives a payment message including power scores. In a second step, the financial institution server provides the system server with a bid (e.g. including proposed interest rates, fees, etc.). The system server determines a winning bid based on the offers from each financial institution server and communicates this winner with the winning financial institution and the DDCPM of the winning user.

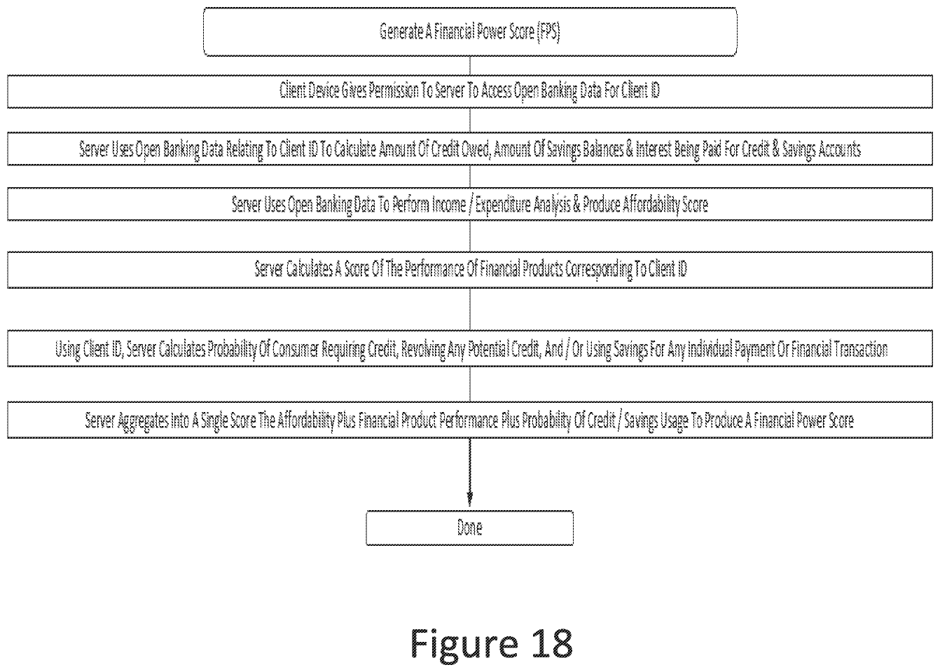

Referring to FIG. 18, there is shown a process for generating a Financial Power Score. The Financial Power Score helps the consumer understand how well their financial products are performing for their financial circumstance at any given point in time. It provides real time data insight into how much credit the consumer is using over specific time periods versus their income and what they are paying for using that credit versus other alternative competitor products. In addition, it provides the consumer with how well the deposit or savings balances are performing and it informs Banks/Lenders the capacity an individual consumer has for credit, how they are likely to use credit (e.g. revolve or pay off) and how much deposits or savings they have available in real time.

In order to generate a Financial Power Score, the Client device 1001 gives permission to system server 200 to access Open Banking/Open Finance Data 1006. Server uses Open Banking/Open Finance data relating to Client ID 1003 to calculate the amount of credit owed, amount of savings balances and interest being paid for credit and savings accounts using the Affordability Calculator 1023. The system server uses Open Banking/Open Finance data to perform income/expenditure analysis using the Affordability Calculator 023 and produce an affordability score. The system server calculates a score of the performance of financial products corresponding to Client ID 1003. Using the Client ID 1003, the system server uses the Credit & Savings Probability Calculator 1024 to calculate the probability of a consumer requiring credit, revolving any potential credit and/or using savings for any individual payment of financial transaction. Server using the Power Scores Calculator 1015, aggregates into a single score, the affordability plus financial product performance plus probability of credit and/or savings usage to produce a Financial Power Score relating to Client ID 1003.

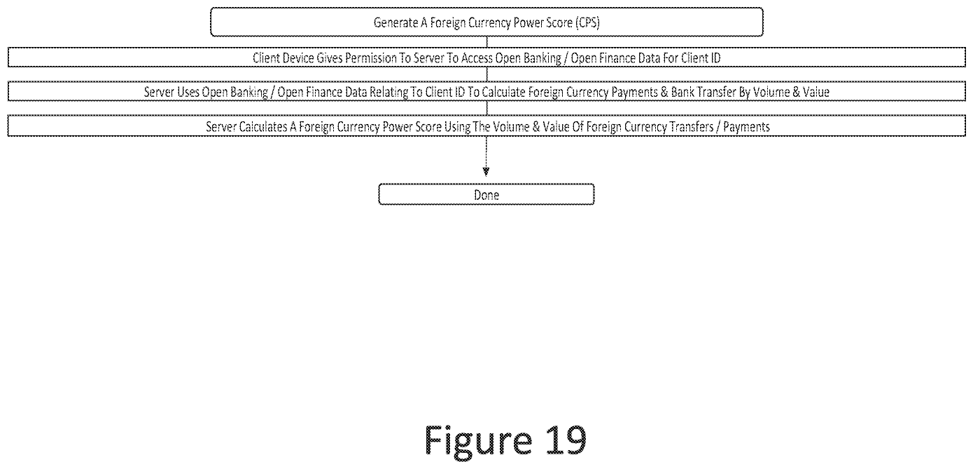

Referring to FIG. 19, the process for generating a Foreign Currency Power Score is shown. This score identifies how frequently a consumer or business sends or receives foreign currency payments/bank transfers or makes foreign currency purchases. The client device 1001 gives permission to the system server 200 to access open banking/open finance data 1006. The system server uses open banking/open finance data relating to client ID 1003 to calculate the volume and value of foreign currency bank transfers/payment and purchases using the transaction categoriser & calculator 1025. The system server then uses the Power Scores Calculator 1015 to calculates a Foreign Currency Power Score relating to Client ID FIG. 1003.

The system disclosed herein enables a user score to be injected into a payment message/schema. The payment message may be sent to market participants (financial institutions) to view the message and make bids to the system for a particular transaction. The financial institution may then utilise the scores to offer personalised/modified terms for a payment or batch of payments, which becomes a balance, such as interest rates, promotional periods, credit durations, fees and charges, rewards etc

The scores injected into payment messages may be used for any financial transaction including but not limited to: retail purchases; foreign currency purchases; foreign currency bank transfers; domestic bank payment transfers; international bank payment transfers; and/or credit balance transfers.

It will be appreciated that similar processes may be used to determine other types of scores. For example, to determine a Creation Power Score, one of the computer devices (e.g. the client device 100, the system server 200, and/or the merchant server 300) may determine the income of a user from third parties by volume and value and determine a volume of satisfactorily completed transactions in order to determine the Creation Power Score. Similarly, to determine a Preference Power Score, the computer device may determine a correlation between the preferences of a user and a merchant and/or a product. This Preference Power Score may then be used to determine a modifier (e.g. a discount) for a merchant and/or a good based on a correlation between the user's preferences and that merchant/good.

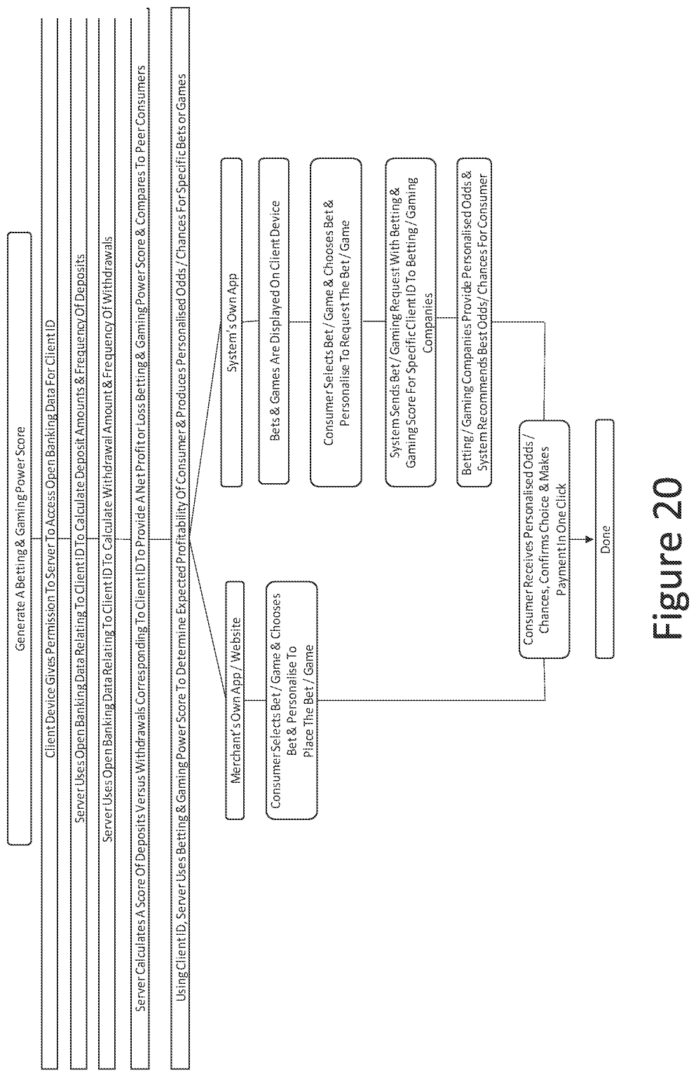

Referring to FIG. 20, there is shown a process for generating and applying a Betting & Gaming Power Score. The Betting & Gaming Power Score provides the deposit amounts over a period of time with specific betting and gaming merchants and the withdrawal amount for those betting and gaming merchants for an individual consumer. This informs the consumer of their success rates and informs the gaming and/or betting merchant of their likely profitability. The score is then used within a betting and gaming environment to receive personalised odds or chances when placing bets on any game or event. A high score means the consumer extracts high withdrawals, e.g. high winnings compared to their deposit amounts and a low score means that the consumer extracts low withdrawals compared to their deposit amounts. The score can also be configured to compare deposit and withdrawal successes to consumers' peers who also bet and/or play games and the frequency of their bets/gaming activities.

In a first step, the client device 100 gives permission to the system server 200 to access open banking/open finance data 106. The system server uses the open banking/open finance data relating to the Client ID 103 to calculate the amount of deposits and withdrawals made and the frequency of deposits and withdrawals. The system server then uses the power scores calculator to produces a betting & gaming power score relating to Client ID.

The betting & gaming power score can then be used by a merchant to personalise odds or chances for a user. For example, the system server 200 may receive the betting & gaming power score and use this score to modify a transaction that is sent to the merchant server, wherein the modifier relates to the potential return (e.g. the odds) for a wager associated with the transaction.

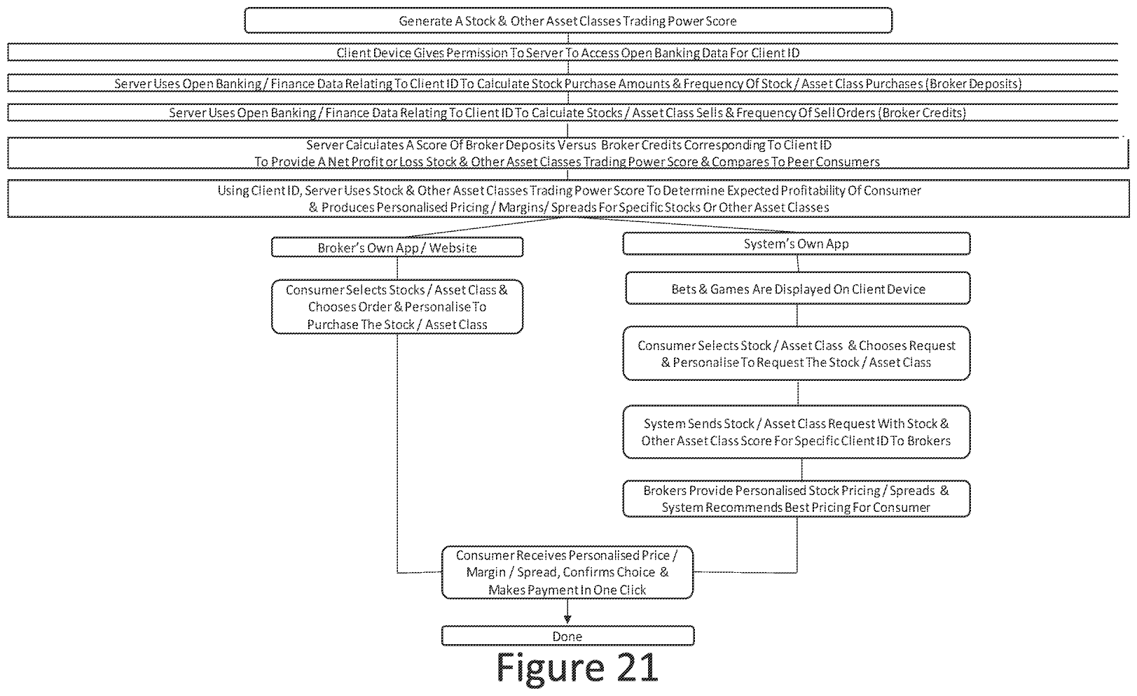

Referring to FIG. 21, there is shown a process for generating a stock, commodity & asset class trading power score. This score provides the price that was paid for a stock or other asset class including fees and charges and what price the stock or other asset class was sold and calculates the number of times the consumer purchases individuals stocks or other asset classes. It also can be configured to compare success rates in the form of profits and unsuccessful trades in the form of losses compared to consumers' peers.

In order to generate a stock, commodity & asset class trading power score, the client device 100 gives permission to the system server 200 to access open banking/open finance data. The system server uses the open banking/open finance data relating to the client id to calculate the amount of broker deposits and broker credits made and the frequency of deposits and credits. The system server then uses the power scores calculator to produce a stock, commodity & asset class trading power score relating to client id . . .

Both the betting gaming & power score and the stock, commodity & asset class trading power score can be applied in the same way as the consumer purchase power score in a merchant website/app environment to obtain personalised pricing or bonuses whilst simultaneously making a payment that can be bid on by financial institutions in a single action click or screen touch etc.

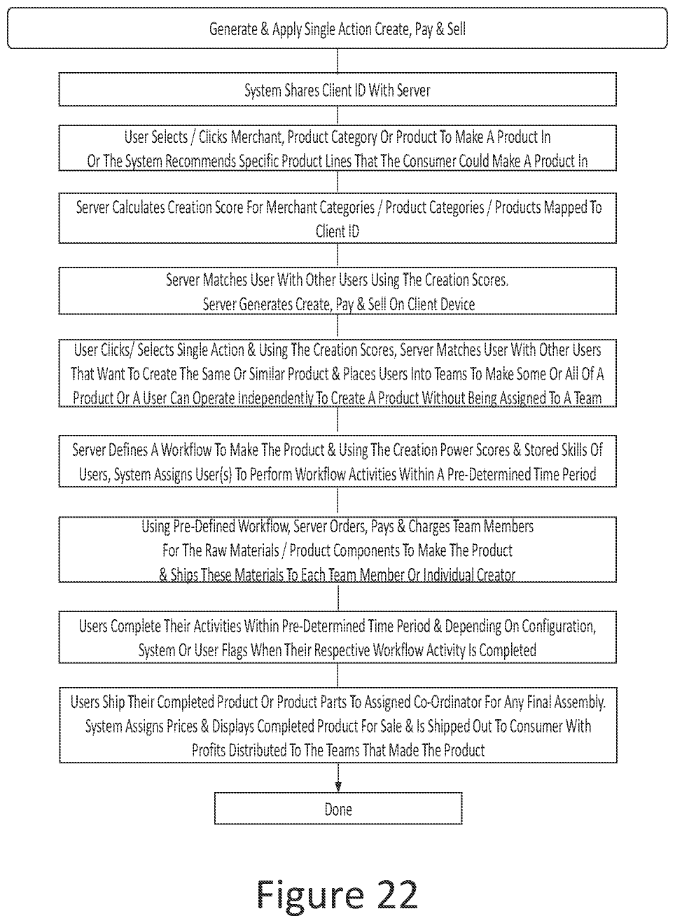

Referring to FIG. 22, there is shown a process for generating and applying a single action one click/touch Create, Pay & Sell. Using (for example) the Creation & Preference Power Scores, this functionality enables individuals to match with other individuals who have similar preferences in products; skill sets that are complimentary and/or who have already created and sold products. It also enables individuals to match and partner with merchants to create personalised products. Once matched, the system creates a workflow and assigns individuals to specific tasks that are needed to create a product. The necessary raw materials or components are distributed to the individuals or teams for them to create the product. Once the product is created, the product is offered for sale within the system's or merchants' app or website and once sold the profits are distributed to the team that has produced the product.

In a first step, the client device 100 shares a client identifier with the system server 200. In a second step, the user selects a product or a merchant that is associated with the manufacture of the product, this may comprise the user selecting a merchant/product that has been recommended by the system server 200 or the merchant server 300. In a third step, the system server calculates a score for each merchant/product associated with the user and in a fourth step the system server matches this user with other users based on their scores (e.g. the system server may match users with similar scores). In a fifth step, the system server matches the user with a subset of these other users that have selected the same merchant or product. In a sixth step and a seventh step, the system server defines a workflow to make the product and orders, pays and charges members associated with this workflow to make the product. In an eighth step, the users compete their activities and in a ninth step, each user ships their completed parts to a co-ordinator for assembly.

### Alternatives and Modifications

It will be understood that the present invention has been described above purely by way of example, and modifications of detail can be made within the scope of the invention.

For example, any of the methods disclosed herein as being performed on the system server 200 may equally be performed on the client device 100 or the merchant server 300. Similarly, any of the methods disclosed herein as being performed on the client device 100 may equally be performed on the system server or the merchant server and any of the methods disclosed herein as being performed on the merchant server may equally be performed on the client device or the system server.

The systems disclosed herein may be implemented using a personal device (e.g. a smartphone or a personal computer); a commercial device, such as the point of sale (POS) system of a supermarket; a server (e.g. the servers of one or more merchants) and/or a combination of these devices.

The system server 200 and the merchant server 300 are arranged to identify the 100 client device and/or a customer using a client ID. This client ID is typically assigned to the client before a purchase is made.

In some embodiments, a client ID may be assigned at the time of purchase and/or a consumer score may be determined at the time of purchase. This may comprise the customer entering identifying information (e.g. a username or a fingerprint) at the time of a purchase, where a client ID can then be generated based on this identifying information. The system server 200 and/or the merchant server 300 may transmit a registration request (such as a webpage or a notification) to the client device to prompt the customer to enter this identifying information.

In cases where the customer is registered with the merchant server 300 at the time of the purchase but not with the system server 200, the merchant server may transmit the identifying information to the system server from a database of the merchant server, where the customer may be prompted to approve this transmission. The merchant server may identify the registration of the user based on identifying information (e.g. a name associated with a purchase request).

Equally, the customer may register with the system server 200 separately (e.g. by providing identifying information to the system server in response to a registration request).

In cases where the customer is registered with the system server 200 at the time of the purchase but not with the merchant server 300, the merchant server may identify this system server registration via a characteristic of the user (e.g. the merchant server may query the system server to determine if a client with a given phone number or email address is registered with the system server). Equally, the client device 100 may be arranged to complete a payment via the system server so that the system server is able to indicate to the merchant server that the customer has registered with the system server.

Where an unregistered customer attempts to make a purchase, the merchant server 300 may transmit a registration request to the customer, where the customer is able to respond by providing a registration associated with the system server 200 (e.g. there may be an option on the notification to register by using an existing system server registration).

In some embodiments, the system server 200 may transmit a discount code to the merchant server 300 without identifying a registration status of the customer so that customers can make purchases without registering with the merchant server.

Reference numerals appearing in the claims are by way of illustration only and shall have no limiting effect on the scope of the claims.

1. An apparatus for transmitting a request, the apparatus comprising:
a processor arranged to:
determine a score for a user in dependence on the behaviour of the user;
identify a request from the user; and
determine a modifier associated with the request in dependence on one or more of: a feature of the request; and a party (e.g. a merchant) associated with the request; and
a communication interface arranged to transmit a transaction to a separate apparatus in dependence on the request, the score, and the modifier.

2. The apparatus of claim 1, wherein the communication interface is arranged to transmit an offer transaction to one or more third party devices, wherein the offer transaction is dependent on the request, the score, the modifier, and, optionally, an input of the user.

3. The apparatus of claim 1, wherein the communication interface is arranged to receive one or more bid transactions from the third party devices, wherein the transaction depends on the bid transactions, preferably wherein each bid transaction is associated with a payment means, and wherein the transaction is dependent on the payment means associated with a winning bid transaction.

4. The apparatus of claim 3, wherein the apparatus is arranged to determine a winning bid based on payment means and/or payment terms associated with each bid.

5. The apparatus of any of claim1 , wherein the request relates to one or more of: a purchase, an exchange; a good; and a service.

6. (canceled)

7. The apparatus of claim 1, wherein:
the apparatus is arranged to receive a merchant value associated with the party from a system server and to determine the modifier based on the merchant value; and/or
the apparatus is arranged to receive the modifier from a system server.

8. The apparatus of claim 1, wherein:
the apparatus is arranged to receive user information indicating the behaviour of the user from a client device, preferably wherein the user information comprises user characteristics and/or user banking data; and/or
the apparatus is arranged to receive the score from a client device.

9. The apparatus of claim 1, wherein the separate apparatus comprises a merchant server.

10. (canceled)

11. The apparatus of claim 1, further comprising a user interface and/or a communication interface for receiving an input of the user, wherein the transaction is dependent on the input of the user, wherein the apparatus is arranged to receive the user input and then to determine the score, the modifier, and the transaction in a single action and/or based on a single user input.

12. (canceled)

13. The apparatus of claim 1, wherein determining the score comprises identifying a client identifier associated with the user and identifying a score associated with the client identifier.

14.-18. (canceled)

19. The apparatus of claim 1, wherein the processor is arranged to determine a time associated with the purchase of a similar good by at least one other user, and wherein the communication interface is arranged to transmit the request in dependence on the determined time.

20. The apparatus of claim 1, wherein the discount is determined in dependence on one or more of:
a previous purchase of the user;
a similar good that the user has purchased previously, preferably a quantity and/or quality associated with the similar good;
a merchant and/or brand associated with a previous purchase of the user; and
an amount previously spent by the user on the good and/or on similar goods.

21. The apparatus of claim 1, wherein the apparatus is associated with a first party and/or brand and the discount is dependent on the behaviour of the user in relation to a second party and/or brand.

22. The apparatus of claim 1, wherein the score is determined in dependence on:
the purchasing and/or financial behaviour and capacity of the user; and/or
a promotion of the good by the user.

23.-31. (canceled)

32. The apparatus of claim 1, wherein the processor The apparatus of is arranged to:
determine one or more further users considering making similar requests and/or purchasing similar good, preferably wherein the modifier is determined in dependence on the further users; and/or
determine and/or output an environmental impact of the request; and/or
determine a plurality of modifiers for a plurality of requests, and output each of the plurality of modifiers.

33. (canceled)

34. The apparatus of claim 1, comprising a processor arranged to determine a lending rate for the user in dependence on the behaviour of the user.

35.-36. (canceled)

37. The apparatus of any of claim 1, comprising a processor arranged to determine a value of the user based on the behaviour of the user.

38. The apparatus of claim 1, wherein the apparatus comprises a processor arranged to determine the modifier based on a permission granted by the user, preferably wherein the processor is arranged to determine a user input specifying types of user information that are useable to determine the modifier.

39.-41. (canceled)

42. A system comprising:
a client device comprising:
a processor for determining user information relating to the behaviour of a user; and
a communication interface for transmitting the user information to a system server;
the system server comprising:
a processor for:
determining a score for the user in dependence on the behaviour of the user; and
determining a modifier associated with a good in dependence on one or more of: the good; and a merchant associated with the good; and
a communication interface for receiving the user information from the client device and transmitting a request to a merchant server, wherein the request is dependent on the good, the score, the modifier, and the input of the user.

43.-45. (Canceled)

46. A method of for transmitting a request, the method comprising:
determining a score for a user in dependence on the behaviour of the user; and
identifying a good;
determining a modifier associated with the good in dependence on one or more of: the good; and a merchant associated with the good; and
transmitting a request in dependence on the good, the score, and the modifier.
